(19) United States
(12) Patent Application Publication
(10) Pub. No.: US 2024/0327550 A1
(43) Pub. Date: Oct. 3, 2024

(54) POLYETHYLENE POWDER, SHAPED ARTICLE, AND SEPARATOR FOR SECONDARY BATTERY

(71) Applicant: Asahi Kasei Kabushiki Kaisha, Tokyo (JP)

(72) Inventors: Kazuya Shikata, Tokyo (JP); Natsumi Shiozawa, Tokyo (JP); Keisuke Hirami, Tokyo (JP); Naoya Okitsu, Tokyo (JP); Tomosato Okubo, Tokyo (JP); Noriko Horiike, Tokyo (JP); Wataru Mizutani, Tokyo (JP)

(73) Assignee: Asahi Kasei Kabushiki Kaisha, Tokyo (JP)

(21) Appl. No.: 18/613,397

(22) Filed: Mar. 22, 2024

(30) Foreign Application Priority Data
Mar. 31, 2023 (JP) 2023-057176
Feb. 26, 2024 (JP) 2024-026736

(51) Int. Cl. C08F 10/02; H01M 50/417; H01M 50/443

(52) U.S. Cl. CPC C08F 10/02; H01M 50/417; H01M 50/443

(57) ABSTRACT

An object of the present invention is to provide, for example, a polyethylene powder that can produce a shaped article excellent in balance between mechanical strength and a rate of thermal shrinkage even when shaped at a high speed. Provided is a polyethylene powder having intrinsic viscosity IV of 1.5 dL/g or more and 15.0 dL/g or less measured in accordance with ISO1628-3 (2010), an amorphous moiety thickness of 5.3 nm or larger and 12.0 nm or smaller, and a crystallite size of 13.9 nm or larger and 18.0 nm or smaller obtained by a reflection method of X-ray diffraction.

### TECHNICAL FIELD

The present invention relates to a polyethylene powder, a shaped article and a separator for secondary battery.

### BACKGROUND ART

Polyethylene powders are employed in various uses by, for example, shaping into sheets, films, and other shapes, and a raw material for separators for secondary battery is one of their important uses. The separators are shaped articles (typically, microporous membranes) that are used for a principal purpose of preventing short circuit caused by the direct contact between positive and negative electrodes inside a battery, and allowing only ions to pass therethrough.

Separators for secondary batteries play a very important role in ensuring the safety of a battery and are required to have high mechanical strength and a small rate of thermal shrinkage.

From the viewpoint of a rate of thermal shrinkage, for example, Patent Literature 1 has proposed a polyethylene powder that produces a shaped article having a small rate of thermal shrinkage by using a catalyst having a saturated active site density in polymerization for the polyethylene powder.

From the viewpoint of mechanical strength, for example, Patent Literature 2 has proposed a polyethylene powder that produces a microporous membrane having high mechanical strength by using two or more types of catalysts in polymerization for the polyethylene powder, and adjusting the degree of molecular entanglement with its active site density changed.

Polyethylene is a crystalline polymer, and the crystal structure of polyethylene is known to contribute to the physical properties of a shaped article made of the polyethylene. From such a viewpoint, for example, Patent Literature 3 has proposed a technique of adjusting the lamellar thickness of an ultrahigh-molecular-weight polyethylene powder in order to improve the mechanical strength for a microporous membrane for lithium ion secondary battery.

### CITATION LIST

### Patent Literature

[Patent Literature 1] International Publication No. WO 2021/241411
[Patent Literature 2] International Publication No. WO 2021/153520
[Patent Literature 3] Japanese Patent No. 6868355

### SUMMARY OF INVENTION

### Technical Problem

For a separator for secondary battery obtained using a polyethylene powder, it is important to achieve both high mechanical strength and a low rate of thermal shrinkage. The mechanical strength and the rate of thermal shrinkage of the separator for secondary battery may each be controlled by the selection of a raw material and the adjustment of film formation conditions. However, these factors are in a tradeoff relationship, and it is difficult for conventional techniques to render both the factors favorable at the same time.

For example, a separator for secondary battery obtained from the polyethylene powder described in Patent Literature 1 is excellent in rate of thermal shrinkage and however, is susceptible to improvement because its balance with mechanical strength has not been adjusted.

A separator for secondary battery obtained from the polyethylene powder described in Patent Literature 2 is excellent in mechanical strength and however, is susceptible to improvement because its balance with a rate of thermal shrinkage has not been adjusted.

Studies on high-speed shaping have been underway in recent years in order to enhance the production efficiency of separators for secondary batteries. For the high-speed shaping into a separator for secondary battery, it is necessary to accelerate a drawing rate in a drawing step in a separator production process. In this context, a high drawing rate gives a separator a high residual stress and therefore tends to deteriorate the rate of thermal shrinkage of the separator.

For example, the polyethylene powder of Patent Literature 1 or 2 is susceptible to improvement because the balance between mechanical strength and a rate of thermal shrinkage has not been adjusted for high-speed shaping.

The polyethylene powder described in Patent Literature 3 is reportedly excellent in physical properties of the resulting shaped article by adjusting a crystal structure, and however, is susceptible to improvement because adjustment has not been made for improvement in balance between mechanical strength and a rate of thermal shrinkage of a microporous membrane obtained from the polyethylene powder and the adjustment of the balance between mechanical strength and a rate of thermal shrinkage has not been studied for high-speed shaping.

The present invention has been made in light of the circumstances described above, and an object of the present invention is to provide, for example, a polyethylene powder that can produce a shaped article excellent in balance between mechanical strength and a rate of thermal shrinkage even when shaped at a high speed.

### Solution to Problem

The present inventor has conducted diligent studies to attain the object and consequently completed the present invention by finding that the object can be attained by controlling intrinsic viscosity IV, an amorphous moiety thickness, and a crystallite size of a polyethylene powder to specific ranges.

Specifically, the present invention encompasses the following aspects.

[1]

A polyethylene powder having:
an intrinsic viscosity IV of 1.5 dL/g or more and 15.0 dL/g or less measured in accordance with ISO1628-3 (2010),
an amorphous moiety thickness of 5.3 nm or larger and 12.0 nm or smaller, and
a crystallite size of 13.9 nm or larger and 18.0 nm or smaller obtained by a reflection method of X-ray diffraction.
   [2]

The polyethylene powder according to [1], wherein a ratio between a monoclinic crystal (010 plane) and an orthorhombic crystal (110 plane) obtained by the reflection method of X-ray diffraction is 1.0 or more and 2.6 or less in terms of monoclinic crystal (010) plane diffraction peak intensity/orthorhombic crystal (110) plane diffraction peak intensity.

[3]

The polyethylene powder according to [1] or [2], wherein a Ti content is 10 ppm or less and an Al content of 20 ppm or less.

[4]

The polyethylene powder according to any of [1] to [3], wherein an average particle size D₅₀ determined by a sieving method is 80 m or larger.

[5]

The polyethylene powder according to any of [1] to [4], wherein an α-olefin content is less than 0.03 mol %.

[6]

A shaped article comprising the polyethylene powder according to any of [1] to [5].

[7]

A separator for secondary battery comprising the shaped article according to [6].

### Advantageous Effect of Invention

The present invention can provide, for example, a polyethylene powder that can produce a shaped article excellent in balance between mechanical strength and a rate of thermal shrinkage even in high-speed shaping.

### DESCRIPTION OF EMBODIMENTS

Hereinafter, an embodiment for carrying out the present invention (hereinafter, simply referred to as the “present embodiment”) will be described in detail. However, the present invention is not intended to be limited by the present embodiment. Various changes or modifications can be made in the present invention within the spirit thereof.

### [Polyethylene Powder]

The polyethylene powder (hereinafter, also simply referred to as the “powder”) of the present embodiment has intrinsic viscosity IV of 1.5 dL/g or more and 15.0 dL/g or less measured in accordance with ISO1628-3 (2010), an amorphous moiety thickness of 5.3 nm or larger and 12.0 nm or smaller, and a crystallite size of 13.9 nm or larger and 18.0 nm or smaller obtained by a reflection method of X-ray diffraction.

The polyethylene powder of the present embodiment is configured as described above and can therefore produce a shaped article excellent in balance between mechanical strength and a rate of thermal shrinkage even when shaped at a high speed.

Furthermore, the polyethylene powder of the present embodiment is configured as described above and therefore tends to be able to produce a shaped article excellent in balance between mechanical strength and a rate of thermal shrinkage even under typical shaping conditions conventionally known in the art.

The intrinsic viscosity IV of the polyethylene powder of the present embodiment is 1.5 dL/g or more. The intrinsic viscosity IV that falls within the range described above tends to more improve the strength of a shaped article. The intrinsic viscosity IV of the polyethylene powder of the present embodiment is 15.0 dL/g or less. The polyethylene powder of the present embodiment having the intrinsic viscosity IV that falls within the range described above tends to have more improved moldability.

From the viewpoint described above, the intrinsic viscosity IV is preferably 2.0 dL/g or more. From the viewpoint described above, the intrinsic viscosity IV is preferably 14.0 dL/g or less, more preferably 13.5 dL/g or less. Thus, the intrinsic viscosity IV is preferably 2.0 dL/g or more and 14.0 dL/g or less, more preferably 2.0 dL/g or more and 13.5 dL/g or less.

The method for controlling the intrinsic viscosity IV to the range mentioned above is not particularly limited and involves, for example, changing the polymerization temperature of a reactor where ethylene is homopolymerized or where ethylene and an olefin copolymerizable therewith are copolymerized. The intrinsic viscosity IV tends to be lower as the polymerization temperature is higher, and tends to be higher as the polymerization temperature is lower. Another method for controlling the intrinsic viscosity IV to the range mentioned above is not particularly limited and involves, for example, changing the type of an organic metal compound for use as a promoter in the homopolymerization of ethylene or the copolymerization of ethylene and an olefin copolymerizable therewith. A further alternative method for controlling the intrinsic viscosity IV to the range mentioned above is not particularly limited and involves, for example, adding a chain transfer agent in the homopolymerization of ethylene or the copolymerization of ethylene and an olefin copolymerizable therewith. The addition of the chain transfer agent tends to decrease the intrinsic viscosity IV of the polyethylene to be produced even at the same polymerization temperature. Examples of the chain transfer agent include, but are not particularly limited to, hydrogen.

In the present embodiment, the intrinsic viscosity IV can be determined by a method described in Examples mentioned later.

### [Amorphous Moiety Thickness and Crystallite Size]

In the present specification, the amorphous moiety thickness is determined according to the following expression using a degree of crystallinity obtained by subjecting the polyethylene powder to a reflection method of X-ray diffraction, and a crystalline long period obtained by a transmission method of wide-angle X-ray scattering.

$$Amorphous moiety thickness = ( 1 - Degree of crystallinity ) \times Crystalline long period$$

In the present specification, the crystallite size means a crystallite size of (110) plane obtained by subjecting the polyethylene powder to the reflection method of X-ray diffraction.

The amorphous moiety thickness of the polyethylene powder of the present embodiment is 5.3 nm or larger and 12.0 nm or smaller.

When the amorphous moiety thickness of the polyethylene powder of the present embodiment falls within the range described above, a kebab moiety is reduced because a shish moiety is long in a shish-kebab structure that may be observed when the polyethylene powder is shaped into a microporous membrane. Thus, a drawing load is decreased during drawing. As a result, the rate of thermal shrinkage tends to be improved. Furthermore, the drawing load is small during drawing even in high-speed shaping. As a result, the rate of thermal shrinkage tends to be improved.

From the viewpoint described above, the amorphous moiety thickness is preferably 7.0 nm or larger and 12.0 nm or smaller, more preferably 9.0 nm or larger and 12.0 nm or smaller.

The crystallite size of the polyethylene powder of the present embodiment is 13.9 nm or larger and 18.0 nm or smaller.

The polyethylene powder of the present embodiment having the crystallite size that falls within the range described above has a high degree of orientation of a shish moiety because the number of shish-kebab structures is small per volume of a microporous membrane. As a result, the strength tends to be improved.

From the viewpoint described above, the crystallite size is preferably 14.5 nm or larger and 18.0 nm or smaller, more preferably 15.0 nm or larger and 18.0 nm or smaller.

Examples of the method for controlling the amorphous moiety thickness and the crystallite size to the ranges described above include, but are not particularly limited to, a method of allowing a strongly entangled polyethylene component to be contained, and thereby suppressing the exertion of a folded structure, and a method of annealing the polyethylene powder so that crystals grow, followed by the rapid cooling of the polyethylene powder.

A specific method involves performing polymerization in an environment having a high temperature and pressure, followed by cooling treatment for the polyethylene powder immediately after polymerization, in order to allow a strongly entangled polyethylene component to be contained. In this context, the polymerization temperature for allowing a strongly entangled polyethylene component to be contained is preferably 84° C. or higher, more preferably 86° C. or higher. The polymerization pressure for allowing a strongly entangled polyethylene component to be contained is preferably 0.4 MPa or higher, more preferably 0.5 MPa or higher. The cooling treatment conditions preferably involve exposing the polyethylene powder to an environment of 40° C. or lower and more preferably involve exposing the polyethylene powder to an environment of 10° C. or lower. The cooling treatment is carried out immediately after a polymerization step in a polyethylene production process and includes, for example, a method of adjusting the temperature of a deaeration step.

The method for controlling the amorphous moiety thickness to a further preferred range includes, in addition to the method described above, a method of using a catalyst having a high active site density for polymerization in order to allow a strongly entangled polyethylene component to be contained. The active site density can be adjusted by the amount of a titanium compound used in preparing a catalyst, and is preferably 0.2 or more, more preferably 0.3 or more, particularly preferably 0.4 or more, in terms of a molar ratio to a magnesium atom contained in a carrier.

The method for controlling the amorphous moiety thickness and the crystallite size to further preferred ranges includes a method of performing finish heat treatment for the polyethylene powder. In this context, the finish heat treatment refers to a treatment involving exposure to a high-temperature environment for a given time and immediately thereafter, exposure to a low-temperature environment. The high-temperature environment is of preferably 80° C. or higher, more preferably 100° C. or higher. The time of exposure to the high-temperature environment is preferably 30 minutes or longer, more preferably 1 hour or longer. The low-temperature environment is of preferably 0° C. or lower, more preferably −70° C. or lower.

The method for controlling the amorphous moiety thickness and the crystallite size to further preferred ranges includes a method of performing the finish heat treatment for the polyethylene powder obtained by polymerization with a catalyst having a high active site density.

The method for controlling the amorphous moiety thickness and the crystallite size to further preferred ranges includes a method of performing polymerization in an environment having a high temperature and pressure, then performing cooling treatment for the polyethylene powder immediately after polymerization, and performing finish heat treatment for the resulting polyethylene powder.

The method for controlling the amorphous moiety thickness and the crystallite size to further preferred ranges includes a method of performing polymerization in an environment having a high temperature and pressure using a catalyst having a high active site density, then performing cooling treatment for the polyethylene powder immediately after polymerization, and performing finish heat treatment for the resulting polyethylene powder.

In the present embodiment, the amorphous moiety thickness and the crystallite size can be determined by methods described in Examples mentioned later.

### [Ratio Between Monoclinic Crystal (010 Plane) and Orthorhombic Crystal (110 Plane)]

In the present specification, the ratio between a monoclinic crystal (010 plane) and an orthorhombic crystal (110 plane) of the polyethylene powder refers to a diffraction peak intensity ratio obtained by a reflection method of X-ray diffraction, and can be determined as monoclinic crystal (010) plane diffraction peak intensity/orthorhombic crystal (110) plane diffraction peak intensity.

The ratio between a monoclinic crystal (010 plane) and an orthorhombic crystal (110 plane) of the polyethylene powder of the present embodiment is preferably 1.0 or more and 2.6 or less.

The polyethylene powder of the present embodiment having the ratio between a monoclinic crystal (010 plane) and an orthorhombic crystal (110 plane) that falls within the range described above has a larger proportion of an orthorhombic crystal having a high melting point than that of a monoclinic crystal, is capable of having a higher heat setting temperature, and can decrease a rate of thermal shrinkage.

From the viewpoint described above, the ratio is more preferably 1.0 or more and 2.2 or less, further preferably 1.0 or more and 1.8 or less.

The method for controlling the ratio between a monoclinic crystal (010 plane) and an orthorhombic crystal (110 plane) to the range described above is not particularly limited. A possible method involves, for example, applying heat to the polyethylene powder to convert a monoclinic crystal to a more stable orthorhombic crystal.

The method for controlling the ratio between a monoclinic crystal (010 plane) and an orthorhombic crystal (110 plane) to the range described above specifically includes a method of performing polymerization in an environment having a high temperature and pressure, followed by cooling treatment for the polyethylene powder immediately after polymerization. In this context, the polymerization temperature is preferably 84° C. or higher, more preferably 86° C. or higher. The polymerization pressure is preferably 0.4 MPa or higher, more preferably 0.5 MPa or higher. The cooling treatment conditions preferably involve exposing the polyethylene powder to an environment of 40° C. or lower and more preferably involve exposing the polyethylene powder to an environment of 10° C. or lower. The cooling treatment is carried out immediately after a polymerization step in a polyethylene production process and includes, for example, a method of adjusting the temperature of a deaeration step.

The method for controlling the ratio between a monoclinic crystal (010 plane) and an orthorhombic crystal (110 plane) to a further preferred range includes a method of performing finish heat treatment for the polyethylene powder. In this context, the finish heat treatment refers to a treatment involving exposure to a high-temperature environment for a given time and immediately thereafter, exposure to a low-temperature environment. The high-temperature environment is of preferably 80° C. or higher, more preferably 100° C. or higher. The time of exposure to the high-temperature environment is preferably 30 minutes or longer, more preferably 1 hour or longer. The low-temperature environment is of preferably 0° C. or lower, more preferably −70° C. or lower.

The method for controlling the ratio between a monoclinic crystal (010 plane) and an orthorhombic crystal (110 plane) to a further preferred range includes a method of performing polymerization in an environment having a high temperature and pressure, then performing cooling treatment for the polyethylene powder immediately after polymerization, and performing finish heat treatment for the resulting polyethylene powder.

In the present embodiment, the ratio between a monoclinic crystal (010 plane) and an orthorhombic crystal (110 plane) can be determined by a method described in Examples mentioned later.

The polyethylene powder of the present embodiment may be, for example, a mixture containing a plurality of polyethylenes differing in intrinsic viscosity, molecular weight distribution, or the like.

The polyethylene powder of the present embodiment may comprise a homopolymer of ethylene (hereinafter, also simply referred to as a “homopolymer”) or may comprise a copolymer of ethylene and an olefin (hereinafter, also referred to as a “comonomer”) copolymerizable with ethylene (hereinafter, also simply referred to as a “copolymer”). The copolymer may be a ternary random copolymer.

Examples of the comonomer include, but are not particularly limited to, α-olefins having 3 or more and 15 or less carbon atoms, cyclic olefins having 3 or more and 15 or less carbon atoms, compounds represented by the formula CH₂═CHR¹ (wherein R¹ is an aryl group having 6 to 12 carbon atoms), and linear, branched, or cyclic dienes having 3 or more and 15 or less carbon atoms. These comonomers may be used each alone or may be used in combination of two or more thereof. Among them, an α-olefin having 3 or more and 15 or less carbon atoms is preferred.

Examples of the α-olefin include, but are not particularly limited to, propylene, 1-butene, 4-methyl-1-pentene, 1-hexene, 1-octene, 1-nonene, 1-decene, 1-undecene, 1-dodecene, 1-tridecene, and 1-tetradecene.

The polyethylene powder of the present embodiment preferably has an α-olefin content of less than 0.03 mol %. In this case, the mechanical strength of a shaped article, such as a microporous membrane, obtained from the polyethylene powder of the present embodiment tends to be more improved. In the present embodiment, when the content of a comonomer including α-olefin in the polyethylene powder is less than 0.03 mol %, the polyethylene powder can be evaluated as being constituted by a homopolymer. Specifically, the α-olefin content of the polyethylene powder can be measured on the basis of a method described in Examples mentioned later (the same holds true for the content of a comonomer other than (α-olefin).

The polyethylene powder of the present embodiment may optionally contain an additive known in the art that may be used in polyethylene powder production. Examples of the additive include, but are not particularly limited to, neutralizers, antioxidants, nucleating agents, and light stabilizers.

The neutralizer is used as a catcher for chlorine contained in polyethylene, or a shaping processing aid or the like. Examples of the neutralizer include, but are not limited to, stearate of alkaline earth metals such as calcium, magnesium, and barium.

The content of the neutralizer in the polyethylene powder of the present embodiment is not particularly limited and is preferably 5,000 ppm or less, more preferably 4,000 ppm or less, further preferably 3,000 ppm or less, based on the total amount of the polyethylene powder.

When the polyethylene powder of the present embodiment is, for example, an ethylene polymer obtained by a slurry polymerization method using a metallocene catalyst, a halogen component can be excluded from catalyst constituents. In such a case, therefore, the neutralizer as mentioned above tends to be not used. Thus, the content of the neutralizer in the polyethylene powder of the present embodiment tends to be equal to or less than the detection limit.

Examples of the antioxidant include, but are not limited to, phenol antioxidants such as dibutylhydroxytoluene, pentaerythrityl-tetrakis[3-(3,5-di-t-butyl-4-hydroxyphenyl)propionate], and octadecyl-3-(3,5-di-t-butyl-4-hydroxyphenyl)propionate.

The content of the antioxidant in the polyethylene powder of the present embodiment is not particularly limited and is preferably 5,000 ppm or less, more preferably 4,000 ppm or less, further preferably 3,000 ppm or less.

Examples of the light stabilizer include, but are not limited to: benzotriazole light stabilizers such as 2-(5-methyl-2-hydroxyphenyl)benzotriazole and 2-(3-t-butyl-5-methyl-2-hydroxyphenyl)-5-chlorobenzotriazole; and hindered amine light stabilizers such as bis(2,2,6,6-tetramethyl-4-piperidine)sebacate and poly[{6-(1,1,3,3-tetramethylbutyl)amino-1,3,5-triazine-2,4-diyl}{(2,2,6,6-tetramethyl-4-piperidyl}hexamethylene{(2,2,6,6-tetramethyl-4-piperidyl)imino}].

The content of the light stabilizer in the polyethylene powder of the present embodiment is not particularly limited and is preferably 5,000 ppm or less, more preferably 4,000 ppm or less, further preferably 3,000 ppm or less.

Examples of the nucleating agent include, but are not limited to, calcium stearate and potassium stearate. For example, “RIKEMASTER” (manufactured by Riken Vitamin Co., Ltd.) is commercially available as a polyethylene resin master batch blended with the nucleating agent.

The content of the nucleating agent in the polyethylene powder of the present embodiment is not particularly limited and is preferably 5,000 ppm or less, more preferably 4,000 ppm or less, further preferably 3,000 ppm or less.

The content of the additive that may be contained in the polyethylene powder of the present embodiment can be determined by extracting the additive in the polyethylene powder by Soxhlet extraction using tetrahydrofuran (THF), and separating and quantifying the extract by liquid chromatography.

### [Titanium Content and Aluminum Content of Polyethylene Powder]

The polyethylene powder of the present embodiment preferably has a titanium (Ti) content of 10 ppm or less and an aluminum (Al) content of 20 ppm or less.

Titanium and aluminum are typically derived from a residue of a polymerization catalyst. Small contents thereof mean small contents of metals derived from a polymerization catalyst in the polyethylene powder. Therefore, the polyethylene powder of the present embodiment having the titanium content and the aluminum content that fall within the ranges described above tends to be preferably applicable as a raw material to a separator for lithium ion secondary battery.

From the viewpoint described above, the titanium content is preferably 5 ppm or less, more preferably 2 ppm or less. From the viewpoint described above, the aluminum content is preferably 10 ppm or less, more preferably 4 ppm or less.

The lower limits of the titanium content and the aluminum content are not particularly limited and may be, for example, detection limit values.

The method for controlling the titanium content and the aluminum content to the ranges described above is not particularly limited, and the contents can be controlled, for example, by adjusting the productivity of the polyethylene powder per unit catalyst.

Specific examples of the method for adjusting the productivity of the polyethylene powder include the elevation of the polymerization temperature of a reactor for production, the elevation of a polymerization pressure, and the elevation of a slurry concentration.

The catalyst used is not particularly limited, and, for example, a general Ziegler-Natta catalyst or metallocene catalyst may be used. A catalyst mentioned later is preferably used.

The titanium content and the aluminum content can be determined by methods described in Examples mentioned later.

### [Average Particle Size D₅₀]

The average particle size D₅₀ of the polyethylene powder of the present embodiment is preferably 80 m or larger.

The polyethylene powder of the present embodiment having the average particle size D₅₀ that falls within the range described above has much better handleability and tends to reduce troubles in a shaping step.

From the viewpoint described above, the average particle size D₅₀ is more preferably 115 m or larger, further preferably 140 m or larger, still further preferably 180 m or larger, even further preferably 200 m or larger, furthermore preferably 205 m or larger.

The method for controlling the average particle size D₅₀ to the range described above is not particularly limited and includes, for example, a method of appropriately adjusting conditions (a polymerization temperature, an ethylene pressure, etc.) within the polymerization system. Specific examples thereof include the elevation of a polymerization temperature and/or a polymerization pressure.

The average particle size D₅₀ of the polyethylene powder of the present embodiment is preferably 400 m or smaller.

The polyethylene powder of the present embodiment having the average particle size D₅₀ that falls within the range described above has more favorable meltability in a solvent (e.g., liquid paraffin), has a more uniform molecular chain distribution, and produces a gel with high orientation. Therefore, a separator for lithium ion secondary battery excellent in mechanical strength tends to be able to be produced.

From the viewpoint described above, the average particle size D₅₀ is more preferably 350 m or smaller, further preferably 300 m or smaller.

The method for controlling the average particle size D₅₀ to the range described above is not particularly limited and includes, for example, a method of appropriately adjusting conditions (a polymerization temperature, an ethylene pressure, etc.) within the polymerization system. Specific examples thereof include the lowering of a polymerization temperature and/or a polymerization pressure.

In the present embodiment, D₅₀ can be determined by a method described in Examples mentioned later.

### [Method for Producing Polyethylene Powder]

### (Catalyst)

Examples of the catalytic for use in the production of the polyethylene powder according to the present embodiment include, but are not particularly limited to, general Ziegler-Natta catalysts. The Ziegler-Natta catalyst is preferably a catalyst for olefin polymerization comprising a solid catalytic [A] and an organic metal compound component [B], wherein the solid catalytic [A] is produced by reacting an organic magnesium compound (hereinafter, also referred to as “(A-1)”) represented by the following formula 1 which is soluble in an inert hydrocarbon solvent with a titanium compound (hereinafter, also referred to as “(A-2)”) represented by the following formula 2:

(A-1):(M¹)_{α}(Mg)_{β}(R²)ₐ(R³)_{b}(Y¹)_{c} Formula 1

wherein M¹ represents a metal atom selected from the group consisting of groups 12, 13, and 14 of the periodic system; R² and R³ each represent a hydrocarbon group having 2 or more and 20 or less carbon atoms; Y¹ represents any of an alkoxy group, a siloxy group, an allyloxy group, an amino group, an amide group, —N═C—R⁴, R⁵, —SR⁶ (wherein R⁴, R⁵, and R⁶ each represent a hydrocarbon group having 1 or more and 20 or less carbon atoms, and when c is 2, Y¹ moieties may be different from each other), and a β-keto acid residue; and α, β, a, b, and c each represent a real number that satisfies the following relationships: 0≤α, 0<β, 0≤a, 0≤b, 0≤c, 0<a+b, 0≤c/(α+β)≤2, and nα+2β=a+b+c (wherein n represents the valence of M¹); and

(A-2):Ti(OR⁷)_{d}X¹_{(4-d)} Formula 2

wherein d represents a real number of 0 or larger and 4 or smaller; R⁷ represents a hydrocarbon group having 1 or more and 20 or less carbon atoms; and X¹ represents a halogen atom.

Specific examples of the inert hydrocarbon solvent for use in the reaction between the compounds (A-1) and (A-2) include, but are not particularly limited to: aliphatic hydrocarbons such as pentane, hexane, and heptane; aromatic hydrocarbons such as benzene and toluene; and alicyclic hydrocarbons such as cyclohexane and methylcyclohexane.

First, the compound (A-1) will be described. The compound (A-1) is represented in the form of an organic magnesium complex compound soluble in an inert hydrocarbon solvent, and encompasses all of dihydrocarbyl magnesium compounds and their complexes with other metal compounds. The relational expression nα+2β=a+b+c of the symbols α, β, a, b, and c represents the stoichiometry of metal atom valence and substituents.

In the formula 1, specific examples of the hydrocarbon group having 2 or more and 20 or less carbon atoms, represented by R² or R³ are, but are not particularly limited to, alkyl groups, cycloalkyl groups, and aryl groups, and include, for example, an ethyl group, a propyl group, a butyl group, a pentyl group, a hexyl group, an octyl group, a decyl group, a cyclohexyl group, and a phenyl group. Among them, alkyl groups are preferred. When α>0, a metal atom selected from the group consisting of groups 12, 13, and 14 of the periodic system can be used as the metal atom M¹. Examples thereof include zinc, boron, and aluminum. Among them, aluminum and zinc are preferred.

The ratio β/α of magnesium to the metal atom M¹ is not particularly limited and is preferably 0.1 or more and 30 or less, more preferably 0.5 or more and 10 or less. In the case of using a predetermined organic magnesium compound wherein α=0, for example, a compound wherein R² is 1-methylpropyl is soluble in an inert hydrocarbon solvent. Such a compound also brings about a preferred consequence to the present embodiment. It is recommended that R² and R³ satisfy any one of the following three conditions (1), (2), and (3) in the formula 1 wherein α=0.

Condition (1): at least one of R² and R³ is a secondary or tertiary alkyl group having 4 or more and 6 or less carbon atoms, preferably both of R² and R³ are alkyl groups having 4 or more and 6 or less carbon atoms and at least one of the groups is a secondary or tertiary alkyl group;

Condition (2): R² and R³ are alkyl groups differing in the number of carbon atoms, preferably R² is an alkyl group having 2 or 3 carbon atoms and R³ is an alkyl group having 4 or more carbon atoms; and

Condition (3): at least one of R² and R³ is a hydrocarbon group having 6 or more carbon atoms, preferably, an alkyl group wherein the total number of carbon atoms contained in R² and R³ is 12 or more.

Hereinafter, these groups will be shown specifically. In Condition (1), specific examples of the secondary or tertiary alkyl group having 4 or more and 6 or less carbon atoms include a 1-methylpropyl group, a 2-methylpropyl group, a 1,1-dimethylethyl group, a 2-methylbutyl group, a 2-ethylpropyl group, a 2,2-dimethylpropyl group, a 2-methylpentyl group, a 2-ethylbutyl group, a 2,2-dimethylbutyl group, and a 2-methyl-2-ethylpropyl group. Among them, a 1-methylpropyl group is particularly preferred.

In Condition (2), specific examples of the alkyl group having 2 or 3 carbon atoms include ethyl, 1-methylethyl, and propyl groups. Among them, an ethyl group is particularly preferred. Specific examples of the alkyl group having 4 or more carbon atoms include, but are not particularly limited to, a butyl group, a pentyl group, a hexyl group, a heptyl group, and an octyl group. Among them, a butyl group and a hexyl group are particularly preferred.

Alternatively, in Condition (3), specific examples of the hydrocarbon group having 6 or more carbon atoms include, but are not particularly limited to, a hexyl group, a heptyl group, an octyl group, a nonyl group, a decyl group, a phenyl group, and a 2-naphthyl group. Among these hydrocarbon groups, alkyl groups are preferred. Among the alkyl groups, a hexyl group and an octyl group are particularly preferred.

According to general tendencies, an alkyl group containing a larger number of carbon atoms tends to be more soluble in an inert hydrocarbon solvent and however, form a solution having a higher viscosity. A moderate long chain alkyl group is therefore preferably used in terms of handling. The organic magnesium compound can be diluted, for use, with an inert hydrocarbon solvent.

This solution can be used without any problem even if trace amounts of Lewis basic compounds such as ethers, esters, and amines are contained or remain therein.

Next, Y¹ will be described. In the formula 1, Y¹ is any of an alkoxy group, a siloxy group, an allyloxy group, an amino group, an amide group, —N═C—R⁴, R⁵, —SR⁶ (wherein R⁴, R⁵, and R⁶ each independently represent a hydrocarbon group having 2 or more and 20 or less carbon atoms), and a β-keto acid residue.

In the formula 1, the hydrocarbon group represented by R⁴, R⁵, or R⁶ is preferably an alkyl or aryl group having 1 or more and 12 or less carbon atoms, particularly preferably an alkyl or aryl group having 3 or more and 10 or less carbon atoms. Examples include, but are not particularly limited to, a methyl group, an ethyl group, a propyl group, a 1-methylethyl group, a butyl group, a 1-methylpropyl group, a 1,1-dimethylethyl group, a pentyl group, a hexyl group, a 2-methylpentyl group, a 2-ethylbutyl group, a 2-ethylpentyl group, a 2-ethylhexyl group, a 2-ethyl-4-methylpentyl group, a 2-propylheptyl group, a 2-ethyl-5-methyloctyl group, an octyl group, a nonyl group, a decyl group, a phenyl group, and a naphthyl group. Among them, a butyl group, a 1-methylpropyl group, a 2-methylpentyl group and a 2-ethylhexyl group are particularly preferred.

In the formula 1, Y¹ is preferably an alkoxy group or a siloxy group. The alkoxy group is not particularly limited and, specifically, is preferably, for example, a methoxy group, an ethoxy group, a propoxy group, a 1-methylethoxy group, a butoxy group, a 1-methylpropoxy group, a 1,1-dimethylethoxy group, a pentoxy group, a hexoxy group, a 2-methylpentoxy group, a 2-ethylbutoxy group, a 2-ethylpentoxy group, a 2-ethylhexoxy group, a 2-ethyl-4-methylpentoxy group, a 2-propylheptoxy group, a 2-ethyl-5-methyloctoxy group, an octoxy group, a phenoxy group, or a naphthoxy group. Among them, a butoxy group, a 1-methylpropoxy group, a 2-methylpentoxy group, and a 2-ethylhexoxy group are more preferred. Specific examples of the siloxy group preferably include, but are not particularly limited to, a hydrodimethylsiloxy group, an ethylhydromethylsiloxy group, a diethylhydrosiloxy group, a trimethylsiloxy group, an ethyldimethylsiloxy group, a diethylmethylsiloxy group, and a triethylsiloxy group. Among them, a hydrodimethylsiloxy group, an ethylhydromethylsiloxy group, a diethylhydrosiloxy group, and a trimethylsiloxy group are more preferred.

In the present embodiment, the compound (A-1) can be synthesized by any method without particular limitations and may be synthesized by reacting, for example, an organic magnesium compound selected from the group consisting of the formulas R²MgX¹ and R²Mg (wherein R² is as defined above, and X¹ represents halogen atom) with an organic metal compound selected from the group consisting of the formulas M¹R³ₙ and M¹R³₍ₙ₋₁₎H (wherein M¹ and R³ are as defined above, and n represents the valence of M¹) at 25° C. or higher and 150° C. or lower in an inert hydrocarbon solvent and, if necessary, subsequently with a compound represented by the formula Y¹—H (wherein Y¹ is as defined above) or with an organic magnesium compound and/or an organic aluminum compound having a functional group represented by Y¹. In the approach of reacting the organic magnesium compound soluble in an inert hydrocarbon solvent with a compound represented by the formula Y¹-H, the order in which the compounds are added to the reaction system is not particularly limited. Any of the following methods can be used: for example, the compound represented by the formula Y¹-H is added into the organic magnesium compound; the organic magnesium compound is added into the compound represented by the formula Y¹-H; and both of the compounds are added at the same time.

In the present embodiment, the molar composition ratio c/(α+β) of Y¹ to all metal atoms in the compound (A-1) is 0≤c/(α+β)≤2, preferably 0≤c/(α+β)<1. The compound (A-1) wherein the molar composition ratio of Y¹ to all metal atoms is 2 or less tends to have better reactivity with the compound (A-2).

Next, the compound (A-2) will be described. The compound (A-2) is a titanium compound represented by the formula 2:

(A-2):Ti(OR⁷)_{d}X¹_{(4-d)} Formula 2

wherein d represents a real number of 0 or larger and 4 or smaller; R⁷ represents a hydrocarbon group having 1 or more and 20 or less carbon atoms; and X¹ represents a halogen atom.

In the formula 2, d is preferably 0 or larger and 1 or smaller, further preferably 0. In the formula 2, specific examples of the hydrocarbon group represented by R⁷ include, but are not particularly limited to: aliphatic hydrocarbon groups such as a methyl group, an ethyl group, a propyl group, a butyl group, a pentyl group, a hexyl group, a 2-ethylhexyl group, a heptyl group, an octyl group, a decyl group, and aryl groups; alicyclic hydrocarbon groups such as a cyclohexyl group, a 2-methylcyclohexyl group, and a cyclopentyl group; and aromatic hydrocarbon groups such as a phenyl group and a naphthyl group. Among them, an aliphatic hydrocarbon group is preferred. Examples of the halogen atom represented by X¹ include chlorine, bromine, and iodine. Among them, chlorine is preferred. In the present embodiment, the compound (A-2) is particularly preferably titanium tetrachloride. In the present embodiment, two or more compounds selected from these compounds may be used as a mixture.

Next, the reaction between the compounds (A-1) and (A-2) will be described. The reaction is preferably carried out in an inert hydrocarbon solvent and further preferably carried out in an aliphatic hydrocarbon solvent such as hexane or heptane. In the reaction, the molar ratio between (A-1) and (A-2) is not particularly limited, and the molar ratio (Ti/Mg) of Ti atom contained in the compound (A-2) to Mg atom contained in the compound (A-1) is preferably 0.1 or more and 10 or less, more preferably 0.3 or more and 3 or less. The reaction temperature is not particularly limited and is preferably within the range of −80° C. or higher and 150° C. or lower, further preferably within the range of −40° C. or higher and 100° C. or lower. The order in which the compounds (A-1) and (A-2) are added to the reaction system is not particularly limited. Any of the following methods can be used: the compound (A-2) is added subsequently to the compound (A-1); the compound (A-1) is added subsequently to the compound (A-2); and the compounds (A-1) and (A-2) are added at the same time. The method of adding the compounds (A-1) and (A-2) at the same time is preferred. In the present embodiment, the solid catalytic [A] obtained by the reaction is used as a slurry solution with an inert hydrocarbon solvent.

Another example of the Ziegler-Natta catalytic used in the present embodiment is preferably a catalyst for olefin polymerization comprising a solid catalytic [C] and an organic metal compound component [B], wherein the solid catalytic [C] is produced by reacting an organic magnesium compound (hereinafter, also referred to as “(C-1)”) represented by the formula 3 which is soluble in an inert hydrocarbon solvent with a chlorinating agent (hereinafter, also referred to as “(C-2)”) represented by the formula 4, and allowing an organic magnesium compound (hereinafter, also referred to as “(C-4)”) represented by the formula 5 which is soluble in an inert hydrocarbon solvent and a titanium compound (hereinafter, also referred to as “(C-5)”) represented by the formula 6 to be supported by a carrier (hereinafter, also referred to as “(C-3)”) thus prepared:

(C-1):(M²)_{γ}(Mg)_{δ}(R⁸)ₑ(R⁹)_{f}(OR¹⁰)_{g} Formula 3

wherein M² represents a metal atom selected from the group consisting of groups 12, 13, and 14 of the periodic system; R⁸, R⁹, and R¹⁰ each represent a hydrocarbon group having 2 or more and 20 or less carbon atoms; and γ, δ, e, f, and g each represent a real number that satisfies the following relationships: 0≤γ, 0<δ, 0≤e, 0≤f, 0≤g, 0<e+f, 0≤g/(γ+δ)≤2, and kγ+2δ=e+f+g (wherein k represents the valence of M²);

(C-2):HₕSiClᵢR¹¹₍₄₋₍ₕ₊ᵢ₎₎ Formula 4

wherein R¹¹ represents a hydrocarbon group having 1 or more and 12 or less carbon atoms; and h and i each represent a real number that satisfies the following relationships: 0<h, 0<i, and 0<h+i≤4;

(C-4):(M¹)_{α}(Mg)_{β}(R²)ₐ(R³)_{b}Y¹_{c} Formula 5

wherein M¹ represents a metal atom selected from the group consisting of groups 12, 13, and 14 of the periodic system; R² and R³ each represent a hydrocarbon group having 2 or more and 20 or less carbon atoms; Y¹ represents any of alkoxy, siloxy, allyloxy, amino, amide, —N═C—R⁴, R⁵, —SR⁶ (wherein R⁴, R⁵, and R⁶ each represent a hydrocarbon group having 1 or more and 20 or less carbon atoms, and when c is 2, Y¹ moieties may be different from each other), and a β-keto acid residue; and α, β, a, b, and c each represent a real number that satisfies the following relationships: 0≤α, 0<β, 0≤a, 0≤b, 0≤c, 0<a+b, 0≤c/(α+β)≤2, and nα+2β=a+b+c (wherein n represents the valence of M¹); and

(C-5):Ti(OR⁷)_{d}X¹_{(4-d)} Formula 6

wherein d represents a real number of 0 or larger and 4 or smaller; R⁷ represents a hydrocarbon group having 1 or more and 20 or less carbon atoms; and X¹ represents a halogen atom.

First, the compound (C-1) will be described. The compound (C-1) is represented in the form of an organic magnesium complex compound soluble in an inert hydrocarbon solvent, but encompasses all of dihydrocarbyl magnesium compounds and their complexes with other metal compounds. In the formula 3, the relational expression kγ+2δ=e+f+g of the symbols γ, δ, e, f, and g represents the stoichiometry of metal atom valence and substituents.

In the formula, specific examples of the hydrocarbon group represented by R⁸ or R⁹ include, but are not particularly limited to, alkyl groups, cycloalkyl groups, and aryl groups, for example, a methyl group, an ethyl group, a propyl group, a butyl group, a pentyl group, a hexyl group, an octyl group, a decyl group, a cyclohexyl group, and a phenyl group. Among them, alkyl groups are preferred for each of R⁸ and R⁹. When γ>0, a metal atom selected from the group consisting of groups 12, 13, and 14 of the periodic system can be used as the metal atom M². Examples thereof include zinc, boron, and aluminum. Among them, aluminum and zinc are particularly preferred.

The ratio δ/γ of magnesium to the metal atom M² is not particularly limited and is preferably 0.1 or more and 30 or less, further preferably 0.5 or more and 10 or less. In the case of using a predetermined organic magnesium compound wherein γ=0, for example, a compound wherein R⁸ is 1-methylpropyl is soluble in an inert hydrocarbon solvent. Such a compound also brings about a preferred consequence to the present embodiment. It is recommended that R⁸ and R⁹ satisfy any one of the following three conditions (1), (2), and (3) in the formula 3 wherein γ=0.

Condition (1) at least one of R⁸ and R⁹ is a secondary or tertiary alkyl group having 4 or more and 6 or less carbon atoms, preferably, both of R⁸ and R⁹ are alkyl groups having 4 or more and 6 or less carbon atoms and at least one of the groups is a secondary or tertiary alkyl group;

Condition (2): R⁸ and R⁹ are alkyl groups differing in the number of carbon atoms, preferably, R⁸ is an alkyl group having 2 or 3 carbon atoms and R⁹ is an alkyl group having 4 or more carbon atoms; and

Condition (3): at least one of R⁸ and R⁹ is a hydrocarbon group having 6 or more carbon atoms, preferably, an alkyl group wherein the total number of carbon atoms contained in R⁸ and R⁹ is 12 or more.

Hereinafter, these groups will be shown specifically. In Condition (1), specific examples of the secondary or tertiary alkyl group having 4 or more and 6 or less carbon atoms include a 1-methylpropyl group, a 2-methylpropyl group, a 1,1-dimethylethyl group, a 2-methylbutyl group, a 2-ethylpropyl group, a 2,2-dimethylpropyl group, a 2-methylpentyl group, a 2-ethylbutyl group, a 2,2-dimethylbutyl group, and a 2-methyl-2-ethylpropyl group. Among them, a 1-methylpropyl group is particularly preferred.

In Condition (2), examples of the alkyl group having 2 or 3 carbon atoms include ethyl, 1-methylethyl, and propyl groups. Among them, an ethyl group is particularly preferred. Specific examples of the alkyl group having 4 or more carbon atoms include, but are not particularly limited to, a butyl group, a pentyl group, a hexyl group, a heptyl group, and an octyl group. Among them, butyl and hexyl groups are particularly preferred.

Alternatively, in Condition (3), specific examples of the hydrocarbon group having 6 or more carbon atoms include, but are not particularly limited to, a hexyl group, a heptyl group, an octyl group, a nonyl group, a decyl group, a phenyl group, and a 2-naphthyl group. Among these hydrocarbon groups, alkyl groups are preferred. Among the alkyl groups, a hexyl group and an octyl group are particularly preferred.

According to general tendencies, an alkyl group containing a larger number of carbon atoms is more soluble in an inert hydrocarbon solvent and forms a solution having a higher viscosity. A moderately long-chain alkyl group is therefore preferably used in terms of handling. The organic magnesium compound is used as an inert hydrocarbon solution. This solution can be used without any problem even if trace amounts of Lewis basic compounds such as ethers, esters, and amines are contained or remain therein.

Next, the alkoxy group (OR¹⁰) will be described. The hydrocarbon group represented by R¹⁰ is preferably an alkyl or aryl group having 1 or more and 12 or less carbon atoms, particularly preferably an alkyl or aryl group having 3 or more and 10 or less carbon atoms. Specific examples of R¹⁰ include, but are not particularly limited to, a methyl group, an ethyl group, a propyl group, a 1-methylethyl group, a butyl group, a 1-methylpropyl group, a 1,1-dimethylethyl group, a pentyl group, a hexyl group, a 2-methylpentyl group, a 2-ethylbutyl group, a 2-ethylpentyl group, a 2-ethylhexyl group, a 2-ethyl-4-methylpentyl group, a 2-propylheptyl group, a 2-ethyl-5-methyloctyl group, an octyl group, a nonyl group, a decyl group, a phenyl group, and a naphthyl group. Among them, a butyl group, a 1-methylpropyl group, a 2-methylpentyl group, and a 2-ethylhexyl group are particularly preferred.

In the present embodiment, the compound (C-1) can be synthesized by any method without particular limitations and is preferably synthesized by a method of reacting an organic magnesium compound selected from the group consisting of the formulas R⁸MgX¹ and R^{B}Mg (wherein R⁸ is as defined above, and X¹ represents a halogen atom) with an organic metal compound selected from the group consisting of the formulas M²R⁹ₖ and M²R⁹₍ₖ₋₁₎H (wherein M², R⁹, and k are as defined above) at a temperature of 25° C. or higher and 150° C. or lower in an inert hydrocarbon solvent and, if necessary, subsequently with an alcohol having a hydrocarbon group represented by R⁹ (wherein R⁹ is as defined above) or an alkoxy magnesium compound and/or an alkoxy aluminum compound having a hydrocarbon group represented by R⁹ which is soluble in an inert hydrocarbon solvent.

In the approach of reacting the organic magnesium compound soluble in an inert hydrocarbon solvent with an alcohol, the order in which the compounds are added to the reaction system is not particularly limited. Any of the following methods can be used: the alcohol is added into the organic magnesium compound; the organic magnesium compound is added into the alcohol; and both of the compounds are added at the same time. In the present embodiment, the ratio between the organic magnesium compound soluble in an inert hydrocarbon solvent and the alcohol in the reaction is not particularly limited, and the molar composition ratio g/(γ+δ) of the alkoxy group to all metal atoms in the resulting alkoxy group-containing organic magnesium compound is 0≤g/(γ+δ)≤2, preferably 0≤g/(γ+δ)<1.

Next, the compound (C-2) will be described. The compound (C-2) is a silicon chloride compound having at least one Si—H bond, represented by the formula 4:

(C-2):HₕSiClᵢR¹¹₍₄₋₍ₕ₊ᵢ₎₎ Formula 4

wherein R¹¹ represents a hydrocarbon group having 1 or more and 12 or less carbon atoms; and h and i each represent a real number that satisfies the following relationships: 0<h, 0<i, and 0<h+i≤4.

In the formula 4, specific examples of the hydrocarbon group represented by R¹¹ include, but are not particularly limited to, aliphatic hydrocarbon groups, alicyclic hydrocarbon groups, and aromatic hydrocarbon groups, for example, a methyl group, an ethyl group, a propyl group, a 1-methylethyl group, a butyl group, a pentyl group, a hexyl group, an octyl group, a decyl group, a cyclohexyl group, and a phenyl group. Among them, alkyl groups having 1 or more and 10 or less carbon atoms are preferred, and alkyl groups having 1 or more and 3 or less carbon atoms, such as a methyl group, an ethyl group, a propyl group, and a 1-methylethyl group are further preferred. Each of h and i is a number larger than 0 that satisfies the relationship h+i≤4. Preferably, i is 2 or larger and 3 or smaller.

Specific examples of such a compound include, but are not particularly limited to, HSiCl₃, HSiCl₂CH₃, HSiCl₂C₂H₅, HSiCl₂(C₃H₇), HSiCl₂(2-C₃H₇), HSiCl₂(C₄H₉), HSiCl₂(C₆H₅), HSiCl₂(4-Cl—C₆H₄), HSiCl₂(CH═CH₂), HSiCl₂(CH₂C₆H₅), HSiCl₂(1-C₁₀H₇), HSiCl₂(CH₂CH═CH₂), H₂SiCl(CH₃), H₂SiCl(C₂H₅), HSiCl(CH₃)₂, HSiCl(C₂H₅)₂, HSiCl (CH₃) (2-C₃H₇), HSiCl (CH₃) (C₆H₅), and HSiCl (C₆H₅)₂. These silicon chloride compounds are used each alone or as a mixture of two or more types selected from these compounds. Among them, HSiCl₃, HSiCl₂CH₃, HSiCl(CH₃)₂, and HSiCl₂(C₃H₇) are preferred, and HSiCl₃ and HSiCl₂CH₃ are more preferred.

Next, the reaction between the compounds (C-1) and (C-2) will be described. For the reaction, the compound (C-2) is preferably used after being diluted in advance with an inert hydrocarbon solvent, a chlorinated hydrocarbon (e.g., 1,2-dichloroethane, o-dichlorobenzene, or dichloromethane), an ether vehicle (e.g., diethyl ether or tetrahydrofuran), or a mixed vehicle thereof. Among them, an inert hydrocarbon solvent is more preferred in terms of the performance of the catalyst. The ratio between (C-1) and (C-2) in the reaction is not particularly limited and is preferably 0.01 mol or higher and 100 mol or lower, further preferably 0.1 mol or higher and 10 mol or lower, of silicon atom contained in the compound (C-2) per 1 mol of magnesium atom contained in the compound (C-1).

The method for reacting the compounds (C-1) and (C-2) is not particularly limited. Any of the following methods can be used: the compounds (C-1) and (C-2) are reacted while introduced at the same time to a reactor (simultaneous addition method); a reactor is charged with the compound (C-2) in advance, and then, the compound (C-1) is introduced to the reactor; and a reactor is charged with the compound (C-1) in advance, and then, the compound (C-2) is introduced to the reactor. Among them, the method of charging a reactor with the compound (C-2) in advance and then introducing the compound (C-1) to the reactor is preferred. The carrier (C-3) obtained by the reaction is preferably separated by filtration or decantation and then thoroughly washed with an inert hydrocarbon solvent to remove unreacted materials or by-products, etc.

The temperature of the reaction between the compounds (C-1) and (C-2) is not particularly limited and is preferably 25° C. or higher and 150° C. or lower, more preferably 30° C. or higher and 120° C. or lower, further preferably 40° C. or higher and 100° C. or lower. In the simultaneous addition method in which the compounds (C-1) and (C-2) are reacted while introduced at the same time to a reactor, the reaction temperature is preferably adjusted to a predetermined temperature by preliminarily setting the temperature of the reactor to a predetermined temperature and adjusting the temperature in the reactor to a predetermined temperature while performing the simultaneous addition. In the method of charging a reactor with the compound (C-2) in advance and then introducing the compound (C-1) to the reactor, the reaction temperature is preferably adjusted to a predetermined temperature by adjusting the temperature of the reactor charged with the silicon chloride compound to a predetermined temperature and adjusting the temperature in the reactor to a predetermined temperature while introducing the organic magnesium compound to the reactor. In the method of charging a reactor with the compound (C-1) in advance and then introducing the compound (C-2) to the reactor, the reaction temperature is preferably adjusted to a predetermined temperature by adjusting the temperature of the reactor charged with the compound (C-1) to a predetermined temperature and adjusting the temperature in the reactor to a predetermined temperature while introducing the compound (C-2) to the reactor.

Next, the organic magnesium compound (C-4) will be described. The compound (C-4) is preferably represented by the formula 5(C-4).

(C-4):(M¹)_{α}(Mg)_{β}(R²)ₐ(R³)_{b}Y¹_{c} Formula 5

wherein M¹ represents a metal atom selected from the group consisting of groups 12, 13, and 14 of the periodic system; R² and R³ each represent a hydrocarbon group having 2 or more and 20 or less carbon atoms; Y¹ represents any of alkoxy, siloxy, allyloxy, amino, amide, —N═C—R⁴, R⁵, —SR⁶ (wherein R⁴, R⁵, and R⁶ each represent a hydrocarbon group having 1 or more and 20 or less carbon atoms, and when c is 2, Y¹ moieties may be different from each other), and a β-keto acid residue; and α, β, a, b, and c each represent a real number that satisfies the following relationships: 0≤α, 0<β, 0≤a, 0≤b, 0<a+b, 0≤c/(α+β)₂, and nα+2β=a+b+c (wherein n represents the valence of M¹).

The amount of the compound (C-4) used is preferably 0.1 or more and 10 or less, more preferably 0.5 or more and 5 or less, in terms of the molar ratio of magnesium atom contained in the compound (C-4) to titanium atom contained in the compound (C-5).

The temperature of the reaction between the compounds (C-4) and (C-5) is not particularly limited and is preferably −80° C. or higher and 150° C. or lower, more preferably within the range of −40° C. or higher and 100° C. or lower.

The concentration of the compound (C-4) in use is not particularly limited and is preferably 0.1 mol/L or higher and 2 mol/L or lower, more preferably 0.5 mol/L or higher and 1.5 mol/L or lower, on the basis of titanium atom contained in the compound (C-4). An inert hydrocarbon solvent is preferably used for diluting the compound (C-4).

The order in which the compounds (C-4) and (C-5) are added to the carrier (C-3) is not particularly limited. Any of the following methods can be used: the compound (C-5) is added subsequently to the compound (C-4); the compound (C-4) is added subsequently to the compound (C-5); and the compounds (C-4) and (C-5) are added at the same time. Among them, the method of adding the compounds (C-4) and (C-5) at the same time is preferred. The reaction between the compounds (C-4) and (C-5) is carried out in an inert hydrocarbon solvent, preferably in an aliphatic hydrocarbon solvent such as hexane or heptane. The catalyst thus obtained is used as a slurry solution with an inert hydrocarbon solvent.

Next, the compound (C-5) will be described. In the present embodiment, the compound (C-5) is a titanium compound represented by the formula 6:

(C-5):Ti(OR⁷)_{d}X¹_{(4-d)} Formula 6

wherein d represents a real number of 0 or larger and 4 or smaller; R⁷ represents a hydrocarbon group having 1 or more and 20 or less carbon atoms; and X¹ represents a halogen atom.

In the formula 6, specific examples of the hydrocarbon group represented by R⁷ include, but are not particularly limited to: aliphatic hydrocarbon groups such as a methyl group, an ethyl group, a propyl group, a butyl group, a pentyl group, a hexyl group, a 2-ethylhexyl group, a heptyl group, an octyl group, a decyl group, and an allyl group; alicyclic hydrocarbon groups such as a cyclohexyl group, a 2-methylcyclohexyl group, and a cyclopentyl group; and aromatic hydrocarbon groups such as a phenyl group and a naphthyl group. Among them, aliphatic hydrocarbon groups are preferred. Specific examples of the halogen atom represented by X¹ include, but are not particularly limited to, chlorine, bromine, and iodine. Among them, chlorine is preferred. One compound selected from these compounds may be used alone as the compound (C-5), or two or more compounds selected from these compounds may be used as a mixture.

The amount of the compound (C-5) used is not particularly limited and is preferably 0.2 or more and 20 or less, more preferably 0.3 or more and 10 or less, particularly preferably 0.4 or more and 5 or less, in terms of the molar ratio to magnesium atom contained in the carrier (C-3).

The reaction temperature for the compound (C-5) is not particularly limited and is preferably −80° C. or higher and 150° C. or lower, further preferably within the range of −40° C. or higher and 100° C. or lower.

In the present embodiment, the method for allowing the compound (C-5) to be supported by the carrier (C-3) is not particularly limited and may involve reacting an excess of the compound (C-5) with the carrier (C-3) and/or using a third component to efficiently support the compound (C-5). A method of achieving this supporting through the reaction between the compound (C-5) and the organic magnesium compound (C-4) is preferred.

Next, the organic metal compound component [B] for use in the present embodiment will be described. The solid catalytic [A] or the solid catalytic [C] for use in the present embodiment can serve as a highly active catalyst for polymerization by combination with the organic metal compound component [B]. The organic metal compound component [B] is also called a “promoter.” The organic metal compound component [B] is preferably a compound containing a metal selected from the group consisting of groups 1, 2, 12, and 13 of the periodic system, particularly preferably an organic aluminum compound and/or an organic magnesium compound.

Compounds represented by the formula 7 are preferably used each alone or as a mixture as the organic aluminum compound:

AlR¹²ⱼZ¹₍₃₋ⱼ₎ Formula 7

wherein R¹² represents a hydrocarbon group having 1 or more and 20 or less carbon atoms; Z¹ represents a group selected from the group consisting of hydrogen atom, halogen atom, alkoxy, allyloxy, and siloxy groups; and j represents any number of 2 or larger and 3 or smaller.

In the formula 7, specific examples of the hydrocarbon group having 1 or more and 20 or less carbon atoms, represented by R¹² include, but are not particularly limited to, aliphatic hydrocarbons, aromatic hydrocarbons, and alicyclic hydrocarbons, for example, trialkyl aluminum compounds such as trimethyl aluminum, triethyl aluminum, tripropyl aluminum, tributyl aluminum, tri(2-methylpropyl) aluminum (or triisobutyl aluminum), tripentyl aluminum, tri(3-methylbutyl) aluminum, trihexyl aluminum, trioctyl aluminum, and tridecyl aluminum; aluminum halide compounds such as diethyl aluminum chloride, ethyl aluminum dichloride, bis(2-methylpropyl) aluminum chloride, ethyl aluminum sesquichloride, and diethyl aluminum bromide; alkoxy aluminum compounds such as diethyl aluminum ethoxide and bis(2-methylpropyl) aluminum butoxide; siloxy aluminum compounds such as dimethylhydrosiloxy aluminum dimethyl, ethylmethylhydrosiloxy aluminum diethyl, and ethyldimethylsiloxy aluminum diethyl; and mixtures thereof. Among them, trialkyl aluminum compounds are particularly preferred.

The organic magnesium compound is preferably an organic magnesium compound represented by the formula 3 which is soluble in an inert hydrocarbon solvent:

(M²)_{γ}(Mg)_{δ}(R⁸)ₑ(R⁹)_{f}(OR¹⁰)_{g} Formula 3

wherein M² represents a metal atom selected from the group consisting of groups 12, 13, and 14 of the periodic system; R⁸, R⁹, and R¹⁰ each represent a hydrocarbon group having 2 or more and 20 or less carbon atoms; and γ, 6, e, f, and g each represent a real number that satisfies the following relationships: 0≤γ, 0<δ, 0≤e, 0≤f, 0≤g, 0<e+f, 0≤g/(γ+δ)≤2, and kγ+2δ=e+f+g (wherein k represents the valence of M²).

This organic magnesium compound is represented in the form of an organic magnesium complex compound soluble in an inert hydrocarbon solvent, but encompasses all of dialkyl magnesium compounds and their complexes with other metal compounds. Although γ, δ, e, f, g, M², R⁸, R⁹, and OR¹⁰ are as already defined, this organic magnesium compound is preferably a compound wherein the ratio δ/γ is in the range of 0.5 or more and 10 or less, more preferably a compound wherein M² is aluminum, because a compound having higher solubility in an inert hydrocarbon solvent is more preferred.

The ratio between the solid catalytic [A] or the solid catalytic [C] and the organic metal compound component [B] to be combined is not particularly limited and is preferably 1 mmol or higher and 3,000 mmol or lower of the organic metal compound component [B] per g of the solid catalytic [A] or the solid catalytic [C].

### (Polymerization Conditions)

Examples of the polymerization method in producing the polyethylene powder of the present embodiment include, but are not limited to, slurry polymerization methods, gas phase polymerization methods, and solution polymerization methods. Among them, a slurry polymerization method is preferred because polymerization heat can be efficiently removed.

In the slurry polymerization method, an inert hydrocarbon vehicle can be used as a vehicle. Further, the olefin itself may be used as a vehicle. Examples of the inert hydrocarbon vehicle include, but are not limited to: aliphatic hydrocarbons such as propane, butane, isobutane, pentane, isopentane, hexane, heptane, octane, decane, dodecane, and kerosene; alicyclic hydrocarbons such as cyclopentane, cyclohexane, and methylcyclopentane; aromatic hydrocarbons such as benzene, toluene, and xylene; hydrogenated hydrocarbons such as ethyl chloride, chlorobenzene, and dichloromethane; and mixtures thereof.

The polymerization temperature in the method for producing the polyethylene powder of the present embodiment is preferably 80° C. or higher, more preferably 84° C. or higher. When the polymerization temperature is 80° C. or higher, industrially more efficient production tends to be achieved. When the polymerization temperature is 84° C. or higher, there is a tendency to contain a strongly entangled polyethylene component, to increase an amorphous moiety thickness and a crystallite size, and to decrease the ratio between a monoclinic crystal (010 plane) and an orthorhombic crystal (110 plane).

The polymerization temperature is preferably 100° C. or lower. When the polymerization temperature is 100° C. or lower, more stable operation tends to be continuously achieved.

The polymerization temperature can also be taken into consideration as a control factor for the intrinsic viscosity IV of the polyethylene powder of the present embodiment. Specifically, the intrinsic viscosity IV of the polyethylene powder of the present embodiment tends to be decreased with increase in polymerization temperature and tends to be increase with decrease in polymerization temperature.

The polymerization pressure in the method for producing the polyethylene powder of the present embodiment is 0.3 MPa or higher, preferably 0.4 MPa or higher. When the polymerization pressure is 0.3 MPa or higher, industrially more efficient production tends to be achieved. When the polymerization pressure is 0.4 MPa or higher, there is a tendency to contain a strongly entangled polyethylene component, to increase an amorphous moiety thickness and a crystallite size, and to decrease the ratio between a monoclinic crystal (010 plane) and an orthorhombic crystal (110 plane).

The polymerization pressure is preferably 1.5 MPa or lower. When the polymerization pressure is 1.5 MPa or lower, partial heat generation caused by rapid polymerization reaction can be suppressed during catalyst introduction. Thus, polyethylene tends to be able to be stably produced.

The polymerization reaction in the method for producing the polyethylene powder of the present embodiment can be performed by any of batch, semicontinuous, and continuous methods.

The polymerization may be performed at two or more divided stages differing in reaction conditions.

In the present embodiment, other components (the additive mentioned above, etc.) known in the art that are useful in polyethylene production (polymerization) can be used, in addition to each component as described above.

### (Cooling Treatment)

The amorphous moiety thickness of the polyethylene powder of the present embodiment can be controlled by cooling treatment immediately after a polymerization step. In this context, the cooling treatment refers to a treatment involving exposure to a low-temperature environment for a given time. The low-temperature environment is of preferably 40° C. or lower, more preferably 10° C. or lower. The time of exposure to the low-temperature environment is preferably 30 minutes or longer, more preferably 1 hour or longer.

The cooling treatment is preferably carried out in a deaeration treatment step that is carried out next to the polymerization step in an industrial production process of the polyethylene powder.

A specific method for the cooling treatment is, for example, but is not limited to, a method of introducing the polyethylene powder immediately after polymerization, together with a polymerization solvent hexane, to a deaerator adjusted to 10° C., and retaining the polyethylene powder for 30 minutes.

The amorphous moiety thickness is controlled by the cooling treatment, presumably because the amorphous moiety thickness is increased by rapidly cooling the polyethylene powder exposed to a high-temperature environment by the polymerization step.

### (Finish Heat Treatment)

The amorphous moiety thickness and the crystallite size of the polyethylene powder of the present embodiment can be controlled by finish heat treatment. In this context, the finish heat treatment refers to a treatment involving exposure to a high-temperature environment for a given time and immediately thereafter, exposure to a low-temperature environment. The high-temperature environment is of preferably 80° C. or higher, more preferably 100° C. or higher. The time of exposure to the high-temperature environment is preferably 30 minutes or longer, more preferably 1 hour or longer. The low-temperature environment is of preferably 0° C. or lower, more preferably −70° C. or lower. The time of exposure to the low-temperature environment is preferably 30 minutes or longer, more preferably 1 hour or longer.

The finish heat treatment is preferably carried out after a drying step and before a packaging step in an industrial production process of the polyethylene powder.

A specific method for the finish heat treatment is, for example, but is not limited to, a method of heating the polyethylene powder at 100° C. for 30 minutes in an oven, and immediately thereafter, exposing the polyethylene powder to a temperature of −70° C. or lower for 30 minutes by dipping in a dry ice-ethanol bath.

The amorphous moiety thickness and the crystallite size are controlled by the finish heat treatment, presumably because polyethylene is annealed at its melting point or lower so that crystals of the polyethylene powder grow, and the amorphous moiety thickness is increased by rapidly cooling the annealed polyethylene powder.

### [Shaped Article]

The shaped article of the present embodiment comprises the polyethylene powder of the present embodiment. In this context, the phrase “comprising the polyethylene powder of the present embodiment” can be used interchangeably with the phrase “obtained by shaping the polyethylene powder of the present embodiment”. The shaped article of the present embodiment is not particularly limited as long as the shaped article comprises the polyethylene powder of the present embodiment. Examples thereof include sheets, films, pellets, and articles having other shapes. Examples of the shaped article of the present embodiment include microporous membranes and heat-set membranes obtained by heat setting thereof, which can be preferably applied as a separator for secondary battery.

The shaped article of the present embodiment may be obtained by subjecting the polyethylene powder of the present embodiment alone to shaping processing or may be obtained by subjecting the polyethylene powder of the present embodiment in combination with a component different from the polyethylene powder of the present embodiment to shaping processing.

### [Separator for Secondary Battery]

The separator for secondary battery of the present embodiment comprises the shaped article of the present embodiment. When the shaped article of the present embodiment is a microporous membrane or a heat-set membrane obtained by heat setting thereof, the membrane can be preferably applied as a separator base material to the separator for secondary battery of the present embodiment. Such a separator base material may be used alone as the separator for secondary battery of the present embodiment, or a coating layer formed on the separator base material may be used as the separator for secondary battery of the present embodiment. Examples of the secondary battery according to the present embodiment include, but are not particularly limited to, lithium ion secondary batteries.

### Examples

Hereinafter, the present invention will be described more specifically with reference to Examples and Comparative Examples. However, the present invention is not intended to be limited by Examples below by any means.

### [Methods and Conditions for Measuring]

The physical properties of polyethylene powders of Examples and Comparative Examples were measured by the following methods.

### (1) Intrinsic Viscosity IV

The intrinsic viscosity IV of each polyethylene powder obtained in Examples and Comparative Examples was measured in accordance with ISO1628-3 (2010).

The solvent used was 20 mL of decahydronaphthalene (supplemented with 1 g/L 2,6-di-t-butyl-4-methylphenol) deaerated with a vacuum pump and purged with nitrogen.

The viscosity tube used was a Cannon-Fenske viscometer” (manufactured by Sibata Scientific Technology Ltd.: product No. -100).

### (2) Crystal Structure Analysis

The degree of crystallinity, the crystallite size ((110) plane crystallite size), and the ratio between a monoclinic crystal (010 plane) and an orthorhombic crystal (110 plane) of each polyethylene powder were calculated from results obtained by the reflection method of X-ray diffraction. The crystalline long period used for calculating an amorphous moiety thickness was obtained by analyzing results obtained by the transmission method of wide-angle X-ray scattering.

### (Measurement by Reflection Method of X-Ray Diffraction)

XRD measurement was performed using an X-ray diffraction apparatus Ultima-IV manufactured by Rigaku Corp. Cu-Kα ray was incident on a sample, and diffracted light was detected in a detector D/tex Ultra manufactured by Rigaku Corp. Measurement was performed under conditions involving a distance of 285 mm between the sample and the detector, an excitation voltage of 40 kV, and a current of 40 mA. A focused optical system was adopted as an optical system, and measurement was performed under slit conditions involving DS=½°, SS=open, and vertical slit=10 mm. The sample was rotated at 1 s⁻¹ at the time of measurement.

### (Measurement by Transmission Method of X-Ray Scattering)

Measurement was performed by the transmission method of small-angle X-ray scattering using NANOPIX manufactured by Rigaku Corp. In pretreatment, a sample impregnated with propylene glycol was measured in order to reduce scattering derived from particle surface. The sample was irradiated with Cu-Kα ray, and scattering was detected in a semiconductor detector Hypix-6000. Measurement was performed under conditions involving a distance of 1312 mm between the sample and the detector and an output of 40 kV and 30 mA. Point focus was adopted to an optical system, and slit sizes were adopted under conditions of 1st slit: ϕ=0.55 mm, 2nd slit: open, and guard slit: ϕ=0.35 mm.

### (Peak Separation Method for Crystalline Diffraction Peak and Amorphous Diffraction Peak)

A straight line was drawn as a baseline in the range from 2θ=9.7° to 2θ=29.0° in the obtained XRD profile and separated into four: an orthorhombic crystal (110) plane diffraction peak, an orthorhombic crystal (200) plane diffraction peak, a monoclinic crystal (010) plane diffraction peak, and an amorphous peak. The (110) plane diffraction peak and the (200) plane diffraction peak were approximated by Voight function, and the (010) plane diffraction peak and the amorphous peak were approximated by Gauss function. Fitting was carried out by the following procedures: first, peak separation was performed by fixing the peak position of the amorphous peak to 20=19.6° and full width at half maximum=6.3°, excluding the monoclinic crystal (010) plane diffraction peak, and not fixing the peak position and the full width at half maximum of the orthorhombic crystal-derived diffraction peaks. Then, peak separation was performed by fixing the peak position of the monoclinic crystal (010) plane diffraction peak to 20=19.4° in a state in which the intensity of the amorphous peak was fixed.

### (Ratio Between Monoclinic Crystal (010 Plane) and Orthorhombic Crystal (110 Plane))

The ratio between a monoclinic crystal (010 plane) and an orthorhombic crystal (110 plane) was determined according to the following expression from the intensity of the orthorhombic crystal (110) plane diffraction peak and the intensity of the monoclinic crystal (010) plane diffraction peak calculated by peak separation.

Ratio between a monoclinic crystal (010 plane) and an orthorhombic crystal (110 plane)=Monoclinic crystal (010) plane diffraction peak intensity/Orthorhombic crystal (110) plane diffraction peak intensity

### (Crystallite Size and Degree of Crystallinity)

The crystallite size ((110) plane crystallite size) was calculated according to Scherrer equation (expression given below) from the full width at half maximum of the orthorhombic crystal (110) plane diffraction peak of polyethylene calculated by peak separation. Also, the degree of crystallinity was obtained as a percent value determined by dividing the sum of the separated orthorhombic crystal-derived crystalline peak and amorphous peak by the area of the orthorhombic crystal-derived crystalline peak.
D(110)=Kλ/(β cos θ)
D(110): crystallite size (nm)
K: 0.9 (constant)
λ: X-ray wavelength (nm)
β: (β₁²-β₂²)^{0.5}
β₁: full width at half maximum (rad) of a (hkl) peak calculated as a result of peak separation
β₂: full width at half maximum (rad) of spread of incident beam
θ: Bragg angle

### (Amorphous Moiety Thickness)

SAXS profile I(q) was obtained by circular average for the X-ray scattering pattern obtained from HyPix-6000. A straight line was drawn as a baseline in the range of 0.1 nm⁻¹<q<0.6 nm⁻¹ in a linear-linear plot of the obtained one-dimensional profile I(q), and fitting was performed by Gauss function. The crystalline long period was calculated according to the following expression when a position at which the maximum intensity was obtained was defined as peak position qₘ derived from the crystalline long period.

$$d = 2 π / {q}_{m}$$

d (nm): crystalline long period
qₘ (mm⁻¹): lamellar-derived peak position in the SAXS profile

The amorphous moiety thickness was calculated according to the following expression using the degree of crystallinity obtained by the reflection method of X-ray diffraction and the crystalline long period obtained by the transmission method of wide-angle X-ray scattering.

$$Amorphous moiety thickness = ( 1 - Degree of crystallinity ) \times Crystalline long period$$

### (3) Ti Content and Al Content

The Ti and Al contents of a polyethylene powder obtained in each of Examples and Comparative Examples were evaluated by high-frequency plasma mass spectrometry in accordance with JIS K 0133. Sample preparation was carried out by pressure decomposition with nitric acid using a microwave decomposition apparatus (model ETHOS TC, manufactured by Milestone General K.K.). The element concentrations of titanium (Ti) and aluminum (Al) as to the prepared sample were measured by the internal standard method using ICP-MS (inductively coupled plasma-mass spectrometer, model X Series X7, manufactured by Thermo Fisher Scientific K.K.), and regarded as a Ti content and an Al content, respectively.

### (4) Average Particle Size D₅₀

Each polyethylene powder was classified through sieves conforming to the specification of JIS Z8801. The sieves used had aperture sizes of 710 μm, 500 μm, 425 μm, 355 μm, 300 μm, 212 μm, 150 μm, 106 μm, 75 μm, and 53 μm. The mass of the powder recovered in each fraction was measured. A cumulative undersize ratio (% by mass) was calculated from the percentage (% by mass) of each fraction based on the total mass of the powder before classification. A particle size at which the cumulative undersize ratio was 50% was regarded as the average particle size D₅₀.

### (5) α-Olefin Content

The α-olefin content of each polyethylene powder was measured in accordance with the method disclosed in G. J. Ray et al., Macromolecules, 10, 773 (1977) and calculated from the area intensity of the signal of methylene carbon observed in a ¹³C-NMR spectrum.
Measurement apparatus: ECS-500 manufactured by JEOL Ltd.
Observed nucleus: ¹³C
Observation frequency: 100.53 MHz
Pulse width: 450 (7.5 μsec)
Pulse program: single pulse dec
PD: 5 s
Measurement temperature: 130° C.
The number of scans: 30,000 or more
Reference: PE (-eee-) signal, 29.9 ppm
Solvent: o-dichlorobenzene-d4
Sample concentration: 5 to 10 wt %
Dissolution temperature: 130 to 140° C.

The polyethylene powder was evaluated as corresponding to a homopolymer or corresponding to a copolymer (α-olefin copolymer) according to the evaluation criteria given below from the obtained α-olefin content. The presence of olefin, other than α-olefin, copolymerizable with ethylene was not confirmed in any case.

### (Evaluation Criteria)

Homopolymer: an α-olefin content of less than 0.03 mol %

Copolymer: an α-olefin content of 0.03 mol % or more

### (6) Evaluation of Strength and Thermal Shrinkage of Shaped Article (Heat-Set Membrane)

30 parts by mass of the polyethylene powder, 70 parts by mass of liquid paraffin (liquid paraffin (product name: Smoil P-350P) manufactured by MORESCO Corp.), and 1 part by mass of an antioxidant (tetrakis[methylene(3,5-di-t-butyl-4-hydroxy-hydrocinnamate)]methane (product name: ANOX20) manufactured by Great Lakes Chemical Japan) were added per 100 parts by mass in total of the polyethylene powder and the liquid paraffin, and stirred to prepare a liquid in a slurry form.

The obtained liquid in a slurry form was charged into Labo Plastomill (unit model: 4C150-01) manufactured by Toyo Seiki Seisaku-sho, Ltd., kneaded at a screw rotational speed of 50 rpm at a constant temperature of 200° C. for 10 minutes, then thermally pressed under conditions of 180° C., 1 MPa, and 3 minutes, further thermally pressed under conditions of 10 MPa and 2 minutes, and then pressed by cooling under conditions of 25° C., 10 MPa, and 5 minutes to form a gel sheet. The thickness of the gel sheet was adjusted to 1.0 mm using a metal frame having a thickness of 1.0 mm.

The gel sheet was drawn 24 hours after gel sheet formation under the following conditions using a batch-type biaxial drawing machine KARO V manufactured by Brückner Maschinenbau GmbH & Co.KG.

### (Drawing Conditions)

Gel sheet size: 95 mm×95 mm
Clip pressure: 4.5 MPa
Preheating and drawing temperatures: 120° C.
Fan air volume: 50%
Preheating time: 45 sec
Drawing rate: 16 mm/s
Draw ratio: 7 times
Drawing scheme: simultaneous biaxial

The drawn gel sheet was dipped in hexane for the removal of liquid paraffin by extraction, and hexane was dried off to obtain a microporous membrane.

The microporous membrane was subjected to heat setting treatment under the conditions given below using a batch-type biaxial drawing machine KARO V manufactured by Brückner Maschinenbau GmbH & Co.KG. to obtain a heat-set membrane. The heat setting temperature was set to a temperature at which the porosity of the heat-set membrane was 35%.
(Heat setting treatment conditions)
Microporous membrane size: 280 mm×280 mm
Clip pressure: 2 MPa
Fan air volume: 50%
Preheating time: 0 sec
Drawing rate: 16.2%/s
Relaxation rate: 6.2%/s
TD maximum ratio: 1.97 times
Rate of TD relaxation: 0.812 times

The porosity of the heat-set membrane was evaluated as follows: the porosity was determined by cutting a sample of 10 cm square out of the heat-set membrane, determining its film thickness (cm) and basis weight (g/cm²), and calculating the porosity according to the following expression from these factors and the true density (g/cm³) of the polyethylene powder.

$$Porosity ( \% ) = ( 1 - Basis weight / ( Film thickness \times True density ) ) \times 100$$

In this context, 0.95 g/cm³ was applied to the true density of the polyethylene powder.

The basis weight-based puncture strength and the rate of thermal shrinkage were evaluated 24 hours after obtainment of the heat-set membrane.

### (Evaluation of Basis Weight-Based Puncture Strength)

First, the heat-set membrane was fixed to a sample holder having an opening of 10 mm in diameter using Handy Compression Tester “KES-G5” manufactured by Kato Tech Co., Ltd. Next, a central part of the fixed heat-set membrane was subjected to a puncture test under conditions involving a radius of curvature of 0.5 mm at the tip of a needle and a puncture rate of 10 mm/min to obtain a puncture strength (gf) as a maximum puncture load. The obtained puncture strength (gf) was divided by a basis weight (g/m²) to calculate basis weight-based puncture strength (gf/(g/m²)). This operation was carried out 3 times using three heat-set membranes, and an average value from the three measurements was regarded as the basis weight-based puncture strength (gf/(g/m²)).

### (Evaluation of Rate of Thermal Shrinkage)

A sample of 6 cm square cut out of the heat-set membrane was placed in an envelope and heated at 120° C. for 1 hour using a blast low-temperature thermostat DKM600 manufactured by Yamato Scientific Co., Ltd. Then, the sample was cooled at room temperature for 15 minutes, and the side length (perimeter) of the sample was measured using a carpenter's square. The rate of thermal shrinkage was calculated by calculating the rate of shrinkage from the perimeter before heating according to the expression given below. This operation was carried out 3 times using three heat-set membranes, and an average value from the three measurements was regarded as the rate of thermal shrinkage (%).

### (Rate of Thermal Shrinkage)

$$Rate of thermal shrinkage ( \% ) = ( 1 - L / 24 ) \times 100$$

L: Perimeter (cm) of the sample after heating

Performance balance was evaluated from the obtained values of the basis weight-based puncture strength and the rate of thermal shrinkage according to the following evaluation criteria.

### (Evaluation Criteria)

⊚: Rate of thermal shrinkage≤0.0625×Basis weight-based puncture strength−0.3750
◯: 0.0625×Basis weight-based puncture strength−0.3750<Rate of thermal shrinkage≤0.1875×Basis weight-based puncture strength−5.1250
Δ: 0.1875×Basis weight-based puncture strength −5.1250<Rate of thermal shrinkage≤0.2500×Basis weight-based puncture strength−6.5000
X: 0.2500×Basis weight-based puncture strength −6.5000<Rate of thermal shrinkage

### (7) Evaluation of Strength and Thermal Shrinkage of Shaped Article (Heat-Set Membrane) Obtained by High-Speed Drawing

A heat-set membrane was prepared by the same method as in the section (6) except that the drawing rate in drawing the gel sheet was set to 32 mm/s. Its basis weight-based puncture strength and rate of thermal shrinkage were evaluated.

Performance balance was evaluated from the obtained values of the basis weight-based puncture strength and the rate of thermal shrinkage according to the following evaluation criteria.

### (Evaluation Criteria)

⊚: Rate of thermal shrinkage≤0.1250×Basis weight-based puncture strength−1.7500
◯: 0.1250×Basis weight-based puncture strength−1.7500<Rate of thermal shrinkage≤0.2500×Basis weight-based puncture strength−6.5000
Δ: 0.2500×Basis weight-based puncture strength−6.500<Rate of thermal shrinkage≤0.3125×Basis weight-based puncture strength−6.8750
X: 0.3125×Basis weight-based puncture strength−6.8750<Rate of thermal shrinkage

### [Catalyst Synthesis Method]

### [Catalyst [A]]

(1) Synthesis of Raw Material [a-1]

An 8 L stainless autoclave thoroughly purged with nitrogen was charged with 2,000 mL of a hexane solution containing 1 mol/L Mg₆(C₄H₉)₁₂Al(C₂H₅)₃ (corresponding to 2000 mmol in total of magnesium and aluminum), 146 mL of a hexane solution containing 5.47 mol/L n-butanol was added dropwise over 3 hours with stirring at 50° C. After the completion, the line was washed with 300 mL of hexane. The stirring was further continued at 50° C. over 2 hours. After the completion of the reaction, the reaction solution was cooled to ordinary temperature and used as raw material [a-1]. The raw material [a-1] had a magnesium concentration of 0.704 mol/L.

### (2) Synthesis of Raw Material[a-2]

An 8 L stainless autoclave thoroughly purged with nitrogen was charged with 2,000 mL of a hexane solution containing 1 mol/L Mg₆(C₄H₉)₁₂Al(C₂H₅)₃ (corresponding to 2000 mmol in total of magnesium and aluminum), and pressure-fed with 240 mL of a hexane solution containing 8.33 mol/L methyl hydrogen polysiloxane (manufactured by Shin-Etsu Chemical Co., Ltd.) with stirring at 80° C., and the stirring was further continued at 80° C. over 2 hours. After the completion of the reaction, the reaction solution was cooled to ordinary temperature and used as raw material [a-2]. The raw material [a-2] had a concentration of 0.786 mol/L in total of magnesium and aluminum.

### (3) Synthesis of Carrier [A-1]

An 8 L stainless autoclave thoroughly purged with nitrogen was charged with 1,000 mL of a hexane solution containing 1 mol/L hydroxytrichlorosilane. To this autoclave, 1340 mL of a hexane solution of the organic magnesium compound as the raw material [a-1](corresponding to 943 mmol of magnesium) was added dropwise at 65° C. over 3 hours, and the reaction was further continued with stirring at 65° C. for 1 hour. After the completion of the reaction, the supernatant was removed, and the resulting solid was washed with 1,800 mL of hexane four times to obtain a carrier [A-1]. As a result of analyzing this carrier, the amount of magnesium contained per g of the solid was 7.5 mmol.

### (4) Preparation of Catalytic [A]

To 1,970 mL of the hexane slurry containing 110 g of the carrier [A-1], 400 mL of a hexane solution containing 1 mol/L titanium tetrachloride and 131 mL of the raw material [a-2] were added at the same time over 3 hours with stirring at 10° C. After the addition, the reaction was continued at 10° C. for 1 hour. After the completion of the reaction, the supernatant was removed, and unreacted raw material components were removed by washing with hexane four times to prepare solid catalytic [A].

### [Catalyst [B]]

To 1,970 mL of the hexane slurry containing 110 g of the carrier [A-1], 103 mL of a hexane solution containing 1 mol/L titanium tetrachloride and 131 mL of the raw material [a-2] were added at the same time over 3 hours with stirring at 10° C. After the addition, the reaction was continued at 10° C. for 1 hour. After the completion of the reaction, the supernatant was removed, and unreacted raw material components were removed by washing with hexane four times to prepare solid catalyst [B].

### [Catalyst [C]]

The solid catalyst [C] used was a metallocene catalyst constituted by the following silica carrier [C1], transition metal compound component [D], and activator [E].

### (Preparation of Silica Carrier [C1])

The precursor of the silica carrier [C1] used was silica having an average particle size of 7 μm, a specific surface area of 660 m²/g, a pore volume of 1.4 mL/g, and compressive strength of 7 MPa. In an 8 L autoclave purged with nitrogen, the silica (130 g) after heat treatment was dispersed in 2500 mL of hexane to obtain a slurry. To the obtained slurry, 195 mL of a hexane solution containing a Lewis acidic compound triethylaluminum (concentration: 1 M) was added at 20° C. under stirring. Then, the mixture was stirred for 2 hours so that the triethylaluminum was reacted with the surface hydroxy group of the silica to prepare 2695 mL of a hexane slurry containing triethylaluminum-adsorbed silica carrier [C1].

### (Preparation of Transition Metal Compound Component [D])

The transition metal compound (D-1) used was [(N-t-butylamido) (tetramethyl-η⁵-cyclopentadienyl)dimethylsilane]titanium-1,3-pentadiene (hereinafter, abbreviated to “complex 1”). The organic magnesium compound (D-2) used was represented by the compositional formula Mg(C₂H₅) (C₄H₉) (hereinafter, abbreviated to “Mg1”). The complex 1 was dissolved at 200 mmol in 1000 mL of isoparaffin hydrocarbon (Isopar E manufactured by Exxon Chemical Co., Inc.). To this solution, 40 mL of a hexane solution containing Mg1 (concentration: 1 M) was added. The concentration of the complex 1 was further adjusted to 0.1 M by the addition of hexane to obtain transition metal compound component [D].

### (Preparation of Activator [E])

Bis(hydrogenated tallow alkyl)methylammonium-tetrakis(pentafluorophenyl) borate (hereinafter, abbreviated to a “borate”) (17.8 g) was added as borate compound (E-1) to 156 mL of toluene and dissolved therein to obtain a 100 mmol/L toluene solution of the borate. To this toluene solution of the borate, 15.6 mL of a hexane solution containing 1 mol/L ethoxydiethyl aluminum was added as (E-2) at room temperature. The borate concentration in the solution was further adjusted to 70 mmol/L by the addition of hexane. Then, the mixture was stirred at room temperature for 1 hour to obtain activator [E] containing the borate.

### (Preparation of Catalyst [C])

To 2695 mL of the slurry of the silica carrier [C1] obtained by the operation, 219 mL of the activator [E] and 175 mL of the transition metal compound component [D] obtained by the operation were added at the same time from different lines using metering pumps with stirring at 400 rpm at 25° C. The addition time was set to 30 minutes. Then, the reaction was continued for 3 hours to prepare solid catalyst [C].

### (Preparation of Liquid Component [F])

The organic magnesium compound [F1] used was represented by the compositional formula AlMg₆(C₂H₅)₃(C₄H₉)₁₂ (hereinafter, abbreviated to “Mg2”). To 200 mL flask, 40 mL of hexane and 38.0 mmol of Mg2 in terms of the total amount of Mg and Al were added with stirring, and 40 mL of hexane containing 2.27 g (37.8 mmol) of methylhydropolysiloxane (viscosity at 25° C.: 20 cSt) was added with stirring at 20° C. Then, the temperature was elevated to 80° C., and the mixture was reacted for 3 hours under stirring to prepare liquid component [F].

### (Preparation of Hydrogenation Catalyst [G])

To 2.0 L SUS autoclave with a stirrer purged with nitrogen, 37.3 g of titanocene dichloride in 1 L of hexane was introduced. While stirred at 500 rpm, 429 mL of a 0.7 mol/L mixture of triisobutylaluminum and diisobutylaluminum hydride (9:1) was added thereto at room temperature over 1 hour using a pump. After the addition, the line was washed with 71 mL of hexane. The stirring was continued for 1 hour to obtain 100 mM/L dark blue homogeneous hydrogenation catalyst [G].

### Example 1

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.476 MPa. Further, hydrogen was added thereto such that the inside pressure was 0.500 MPa. Further, 10.0 mg of the catalyst [A] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 13,600 g per g of the catalyst.

Scales and an extremely coarse powder were removed using a sieve having an aperture size of 425 m. The physical property evaluation of the polyethylene powder was carried out. The evaluation results are shown in Table 1.

### Example 2

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.493 MPa. Further, hydrogen was added thereto such that the inside pressure was 0.500 MPa. Further, 10.0 mg of the catalyst [A] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 19,400 g per g of the catalyst.

Scales and an extremely coarse powder were removed using a sieve having an aperture size of 425 m. The physical property evaluation of the polyethylene powder was carried out. The evaluation results are shown in Table 1.

### Example 31

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.490 MPa. Further, hydrogen was added thereto such that the inside pressure was 0.500 MPa. Further, 10.0 mg of the catalyst [B] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 18,600 g per g of the catalyst.

Scales and an extremely coarse powder were removed using a sieve having an aperture size of 425 m. The physical property evaluation of the polyethylene powder was carried out. The evaluation results are shown in Table 1.

### Example 4

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.480 MPa. Further, hydrogen was added thereto such that the inside pressure was 0.500 MPa. Further, 10.0 mg of the catalyst [B] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 16,700 g per g of the catalyst.

Scales and an extremely coarse powder were removed using a sieve having an aperture size of 425 m. The physical property evaluation of the polyethylene powder was carried out. The evaluation results are shown in Table 1.

### Example 5

Polymerization for a polyethylene powder was performed by the following method using a 1.5 L stainless autoclave polymerization reactor thoroughly purged with nitrogen.

First, the polymerization reactor heated to 84° C. was charged with 800 mL of hexane as a solvent, and 0.4 mmol of the raw material [a-2] was added thereto. Next, ethylene was added thereto such that the inside pressure was 0.396 MPa. Further, hydrogen was added thereto such that the inside pressure was 0.400 MPa. Further, 10.0 mg of the catalyst [B] was added thereto. While the inside temperature was kept at 84° C., polymerization was performed for 60 minutes with stirring at a stirring rate of 1000 rpm. During the polymerization, the inside pressure was kept at 0.400 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 35° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 12,000 g per g of the catalyst.

Scales and an extremely coarse powder were removed using a sieve having an aperture size of 425 m. The physical property evaluation of the polyethylene powder was carried out. The evaluation results are shown in Table 1.

### Example 6

Polymerization for a polyethylene powder was performed by the following method using a 1.5 L stainless autoclave polymerization reactor thoroughly purged with nitrogen.

First, the polymerization reactor heated to 84° C. was charged with 800 mL of hexane as a solvent, and 0.4 mmol of the raw material [a-2] was added thereto. Next, ethylene was added thereto such that the inside pressure was 0.374 MPa. Further, 1-butene was added thereto such that the inside pressure was 0.386 MPa. Further, hydrogen was added thereto such that the inside pressure was 0.400 MPa. Further, 10.0 mg of the catalyst [B] was added thereto. While the inside temperature was kept at 84° C., polymerization was performed for 60 minutes with stirring at a stirring rate of 1000 rpm. During the polymerization, the inside pressure was kept at 0.400 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 35° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 12,700 g per g of the catalyst.

Scales and an extremely coarse powder were removed using a sieve having an aperture size of 425 m. The physical property evaluation of the polyethylene powder was carried out. The evaluation results are shown in Table 1.

### Example 7

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.491 MPa. Further, hydrogen was added thereto such that the inside pressure was 0.500 MPa. Further, 10.0 mg of the catalyst [A] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 15,800 g per g of the catalyst.

Scales and an extremely coarse powder were removed using a sieve having an aperture size of 425 m. The physical property evaluation of the polyethylene powder was carried out. The evaluation results are shown in Table 1.

### Example 81

Polymerization for a polyethylene powder was performed by the following method using a 1.5 L stainless autoclave polymerization reactor thoroughly purged with nitrogen.

First, the polymerization reactor heated to 80° C. was charged with 800 mL of hexane as a solvent, and 0.4 mmol of the raw material [a-2] was added thereto. Next, ethylene was added thereto such that the inside pressure was 0.289 MPa. Further, hydrogen was added thereto such that the inside pressure was 0.300 MPa. Further, 10.0 mg of the catalyst [A] was added thereto. While the inside temperature was kept at 80° C., polymerization was performed for 60 minutes with stirring at a stirring rate of 1000 rpm. During the polymerization, the inside pressure was kept at 0.300 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 50° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 16,500 g per g of the catalyst.

Scales and an extremely coarse powder were removed using a sieve having an aperture size of 425 m. The physical property evaluation of the polyethylene powder was carried out. The evaluation results are shown in Table 1.

### Example 9

Polymerization for a polyethylene powder was performed by the following method using a 1.5 L stainless autoclave polymerization reactor thoroughly purged with nitrogen.

First, the polymerization reactor heated to 80° C. was charged with 800 mL of hexane as a solvent, and 0.4 mmol of the raw material [a-2] was added thereto. Next, ethylene was added thereto such that the inside pressure was 0.286 MPa. Further, hydrogen was added thereto such that the inside pressure was 0.300 MPa. Further, 10.0 mg of the catalyst [B] was added thereto. While the inside temperature was kept at 80° C., polymerization was performed for 60 minutes with stirring at a stirring rate of 1000 rpm. During the polymerization, the inside pressure was kept at 0.300 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 50° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 16,000 g per g of the catalyst.

Scales and an extremely coarse powder were removed using a sieve having an aperture size of 425 m. The physical property evaluation of the polyethylene powder was carried out. The evaluation results are shown in Table 1.

### Example 10

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.498 MPa. Further, hydrogen was added thereto such that the inside pressure was 0.500 MPa. Further, 10.0 mg of the catalyst [A] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 22,000 g per g of the catalyst.

Scales and an extremely coarse powder were removed using a sieve having an aperture size of 425 m. The physical property evaluation of the polyethylene powder was carried out. The evaluation results are shown in Table 1.

### Example 11

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.49985 MPa. Further, hydrogen was added thereto such that the inside pressure was 0.500 MPa. Further, 10.0 mg of the catalyst [A] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 25,900 g per g of the catalyst.

Scales and an extremely coarse powder were removed using a sieve having an aperture size of 425 m. The physical property evaluation of the polyethylene powder was carried out. The evaluation results are shown in Table 2.

### Example 12

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.495 MPa. Further, hydrogen was added thereto such that the inside pressure was 0.500 MPa. Further, 10.0 mg of the catalyst [A] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 17,700 g per g of the catalyst.

Scales and an extremely coarse powder were removed using a sieve having an aperture size of 425 m. The physical property evaluation of the polyethylene powder was carried out. The evaluation results are shown in Table 2.

### Example 13

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.342 MPa. Further, hydrogen was added thereto such that the inside pressure was 0.500 MPa. Further, 10.0 mg of the catalyst [A] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 15,600 g per g of the catalyst.

Scales and an extremely coarse powder were removed using a sieve having an aperture size of 425 m. The physical property evaluation of the polyethylene powder was carried out. The evaluation results are shown in Table 2.

### Example 14

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.489 MPa. Further, 1-butene was added thereto such that the inside pressure was 0.494 MPa. Further, hydrogen was added thereto such that the inside pressure was 0.500 MPa. Further, 10.0 mg of the catalyst [A] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

The polymerization activity in the polymerization reactor was 24,100 g per g of the catalyst.

Scales and an extremely coarse powder were removed using a sieve having an aperture size of 425 m. The physical property evaluation of the polyethylene powder was carried out. The evaluation results are shown in Table 2.

### Example 15

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.476 MPa. Further, hydrogen was added thereto such that the inside pressure was 0.500 MPa. Further, 10.0 mg of the catalyst [B] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

The polymerization activity in the polymerization reactor was 16,200 g per g of the catalyst.

Scales and an extremely coarse powder were removed using a sieve having an aperture size of 425 m. The physical property evaluation of the polyethylene powder was carried out. The evaluation results are shown in Table 2.

### Comparative Example 1

Polymerization for a polyethylene powder was performed by the following method using a 1.5 L stainless autoclave polymerization reactor thoroughly purged with nitrogen.

First, the polymerization reactor heated to 80° C. was charged with 800 mL of hexane as a solvent, and 0.4 mmol of the raw material [a-2] was added thereto. Next, ethylene was added thereto such that the inside pressure was 0.282 MPa. Further, hydrogen was added thereto such that the inside pressure was 0.300 MPa. Further, 10.0 mg of the catalyst [B] was added thereto. While the inside temperature was kept at 80° C., polymerization was performed for 60 minutes with stirring at a stirring rate of 1000 rpm. During the polymerization, the inside pressure was kept at 0.300 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 50° C. and retained for 30 minutes to perform cooling treatment.

Then, the reaction mixture was filtered and dried in air to obtain a polyethylene powder.

The polymerization activity in the polymerization reactor was 6,800 g per g of the catalyst.

Scales and an extremely coarse powder were removed using a sieve having an aperture size of 425 m. The physical property evaluation of the polyethylene powder was carried out. The evaluation results are shown in Table 2.

### Comparative Example 2

Polymerization for a polyethylene powder was performed by the following method using a 1.5 L stainless autoclave polymerization reactor thoroughly purged with nitrogen.

First, the polymerization reactor heated to 80° C. was charged with 800 mL of hexane as a solvent, and 0.4 mmol of the raw material [a-2] was added thereto. Next, ethylene was added thereto such that the inside pressure was 0.295 MPa. Further, hydrogen was added thereto such that the inside pressure was 0.300 MPa. Further, 10.0 mg of the catalyst [A] was added thereto. While the inside temperature was kept at 80° C., polymerization was performed for 60 minutes with stirring at a stirring rate of 1000 rpm. During the polymerization, the inside pressure was kept at 0.300 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 50° C. and retained for 30 minutes to perform cooling treatment.

Then, the reaction mixture was filtered and dried in air to obtain a polyethylene powder.

The polymerization activity in the polymerization reactor was 18,100 g per g of the catalyst.

Scales and an extremely coarse powder were removed using a sieve having an aperture size of 425 m. The physical property evaluation of the polyethylene powder was carried out. The evaluation results are shown in Table 2.

### Comparative Example 3

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.500 MPa. Further, 10.0 mg of the catalyst [A] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 25,900 g per g of the catalyst.

Scales and an extremely coarse powder were removed using a sieve having an aperture size of 425 m. The physical property evaluation of the polyethylene powder was carried out. The evaluation results are shown in Table 2.

### Comparative Example 4

Polymerization for a polyethylene powder was performed by the following method using a 1.5 L stainless autoclave polymerization reactor thoroughly purged with nitrogen.

First, the polymerization reactor heated to 86° C. was charged with 800 mL of hexane as a solvent, and 0.4 mmol of the raw material [a-2] was added thereto. Next, ethylene was added thereto such that the inside pressure was 0.219 MPa. Further, hydrogen was added thereto such that the inside pressure was 0.500 MPa. Further, 10.0 mg of the catalyst [A] was added thereto. While the inside temperature was kept at 86° C., polymerization was performed for 60 minutes with stirring at a stirring rate of 1000 rpm. During the polymerization, the inside pressure was kept at 0.500 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 8° C. and retained for 30 minutes to perform cooling treatment.

Then, the reaction mixture was filtered and dried in air to obtain a polyethylene powder.

Then, the polyethylene powder was heated at 110° C. for 30 minutes in an oven. Immediately thereafter, the polyethylene powder was dipped in a dry ice-ethanol bath and thereby exposed to a temperature of −70° C. or lower for 30 minutes to perform finish heat treatment.

The polymerization activity in the polymerization reactor was 16,700 g per g of the catalyst.

Scales and an extremely coarse powder were removed using a sieve having an aperture size of 425 m. The physical property evaluation of the polyethylene powder was carried out. The evaluation results are shown in Table 2.

### Comparative Example 5

Polymerization for a polyethylene powder was performed by the following method using a 1.5 L stainless autoclave polymerization reactor thoroughly purged with nitrogen.

First, the polymerization reactor heated to 80° C. was charged with 800 mL of hexane as a solvent, and 0.4 mmol of the raw material [a-2] was added thereto. Next, ethylene was added thereto such that the inside pressure was 0.285 MPa. Further, hydrogen was added thereto such that the inside pressure was 0.300 MPa. Further, 10.0 mg of the catalyst [B] was added thereto. While the inside temperature was kept at 80° C., polymerization was performed for 60 minutes with stirring at a stirring rate of 1000 rpm. During the polymerization, the inside pressure was kept at 0.300 MPa by supplying ethylene on an as-needed basis. After the completion of the polymerization, the reaction mixture (polymer slurry) was discharged from the polymerization reactor, and the catalyst was inactivated with methanol.

Then, the reaction mixture was cooled to 50° C. and retained for 30 minutes to perform cooling treatment.

Then, the reaction mixture was filtered and dried in air to obtain a polyethylene powder.

The polymerization activity in the polymerization reactor was 10,300 g per g of the catalyst.

Scales and an extremely coarse powder were removed using a sieve having an aperture size of 425 m. After addition of 1,000 ppm each of calcium stearate and potassium stearate, the physical property evaluation of the polyethylene powder was carried out. The evaluation results are shown in Table 2.

### Comparative Example 6

A solvent, a raw material, and a catalyst given below were supplied to a vessel-type 300 L polymerization reactor equipped with a stirrer. The polymerization temperature was kept at 75° C. by jacket cooling. Normal hexane was supplied thereto as a solvent at 60 L/hr. The catalyst [C] was supplied thereto such that the production rate was 10 kg/hr. The liquid component [F] was supplied thereto at 6 mmol/hr in terms of the total amount of Mg and Al. Hydrogen was supplied at 2 NL/hr to a feed piping for the catalyst [C]. The hydrogenation catalyst [G] was separately supplied to this feed piping such that the concentration in the reactor was 0.3 mol/L. Continuous polymerization was performed by supplying ethylene under conditions involving a polymerization temperature of 75° C., a polymerization pressure of 0.8 MPa, and an average residence time of 2.2 hours. A polymerization slurry in the polymerization reactor was introduced to a flash tank having a pressure of 0.05 MPaG and a temperature of 60° C. such that the level in the polymerization reactor was kept constant. Unreacted ethylene and hydrogen were separated. The slurry of the ultrahigh-molecular-weight ethylene polymer thus obtained was continuously sent from the flash tank to a centrifuge through a pump to separate the polymer from the solvent. The separated powder of the ultrahigh-molecular-weight ethylene polymer was sent to a dryer controlled to 80° C., and dried by nitrogen blow.

The polymerization activity in the polymerization reactor was 13,000 g per g of the catalyst.

Scales and an extremely coarse powder were removed using a sieve having an aperture size of 425 m. The physical property evaluation of the polyethylene powder was carried out. The evaluation results are shown in Table 2.

TABLE 1

| | | Exam- | Exam- | Exam- | Exam- | Exam- | Exam- | Exam- | Exam- | Exam- | Exam- |
|---|---|---|---|---|---|---|---|---|---|---|---|
| Item | Unit | ple 1 | ple 2 | ple 3 | ple 4 | ple 5 | ple 6 | ple 7 | ple 8 | ple 9 | ple 10 |
| Intrinsic viscosity IV | dL/g | 4.6 | 7.1 | 6.5 | 5.2 | 7.8 | 4.7 | 6.3 | 5.8 | 5.2 | 9.5 |
| Amorphous moiety | nm | 11.8 | 9.1 | 8.8 | 7.3 | 6.8 | 5.4 | 10.6 | 8.2 | 6.7 | 11.0 |
| thickness | | | | | | | | | | | |
| Crystallite size | nm | 17.5 | 17.0 | 17.3 | 16.7 | 17.1 | 16.2 | 15.6 | 14.7 | 14.7 | 15.4 |
| Ratio between monoclinic | — | 1.1 | 1.7 | 1.3 | 1.7 | 1.5 | 1.2 | 1.2 | 1.9 | 2.0 | 1.5 |
| crystal (010 plane) and | | | | | | | | | | | |
| orthorhombic crystal | | | | | | | | | | | |
| (110 plane) | | | | | | | | | | | |
| Amount of Ti | ppm | 1.8 | 1.4 | 1.5 | 1.7 | 1.8 | 1.8 | 1.6 | 1.7 | 1.7 | 1.3 |
| Amount of Al | ppm | 3.6 | 2.7 | 2.9 | 3.4 | 3.8 | 3.7 | 3.7 | 3.4 | 3.5 | 2.6 |
| Average particle size D50 | μm | 208 | 226 | 221 | 212 | 205 | 207 | 218 | 213 | 210 | 232 |
| Presence or absence of | — | Homo- | Homo- | Homo- | Homo- | Homo- | Copol- | Homo- | Homo- | Homo- | Homo- |
| α-olefin | | polymer | polymer | polymer | polymer | polymer | ymer | polymer | polymer | polymer | polymer |
| Basis weight-based | gf/ | 57 | 90 | 88 | 63 | 91 | 55 | 88 | 68 | 60 | 97 |
| puncture strength | (g/m²) | | | | | | | | | | |
| Rate of thermal shrinkage | % | 2 | 3 | 9 | 4 | 11 | 5 | 3 | 9 | 8 | 5 |
| Performance balance | — | ⊚ | ⊚ | ◯ | ◯ | ◯ | ◯ | ⊚ | Δ | Δ | ⊚ |
| Basis weight-based | gf/ | 60 | 92 | 90 | 67 | 93 | 58 | 90 | 71 | 63 | 100 |
| puncture strength | (g/m²) | | | | | | | | | | |
| (high-speed shaping) | | | | | | | | | | | |
| Rate of thermal shrinkage | % | 4 | 7 | 14 | 9 | 22 | 10 | 6 | 11 | 12 | 9 |
| (high-speed shaping) | | | | | | | | | | | |
| Performance balance | — | ⊚ | ⊚ | ◯ | ◯ | Δ | Δ | ⊚ | ◯ | Δ | ⊚ |
| (high-speed shaping) | | | | | | | | | | | |

TABLE 2

| | | Example | Example | Example | Example | Example | Comparative |
|---|---|---|---|---|---|---|---|
| Item | Unit | 11 | 12 | 13 | 14 | 15 | Example 1 |
| Intrinsic viscosity IV | dL/g | 13.2 | 3.8 | 2.0 | 7.6 | 5.0 | 4.7 |
| Amorphous moiety thickness | nm | 10.2 | 11.8 | 10.4 | 5.5 | 5.4 | 5.0 |
| Crystallite size | nm | 16.8 | 17.1 | 16.1 | 14.1 | 14.0 | 14.1 |
| Ratio between monoclinic | — | 1.1 | 1.4 | 1.3 | 2.4 | 2.7 | 2.7 |
| crystal (010 plane) and | | | | | | | |
| orthorhombic crystal | | | | | | | |
| (110 plane) | | | | | | | |
| Amount of Ti | ppm | 0.9 | 1.6 | 1.6 | 1.1 | 1.7 | 2.0 |
| Amount of Al | ppm | 2.0 | 3.1 | 3.7 | 2.3 | 3.5 | 4.0 |
| Average particle size D50 | μm | 244 | 215 | 219 | 237 | 212 | 202 |
| Presence or absence of | — | Homo- | Homo- | Homo- | Copol- | Homo- | Homo- |
| α-olefin | | polymer | polymer | polymer | ymer | polymer | polymer |
| Basis weight-based | gf/ | 108 | 52 | 40 | 88 | 58 | 50 |
| puncture strength | (g/m²) | | | | | | |
| Rate of thermal shrinkage | % | 5 | 2 | 1 | 14 | 8 | 10 |
| Performance balance | — | ⊚ | ⊚ | ⊚ | Δ | Δ | X |
| Basis weight-based puncture | gf/ | 110 | 55 | 44 | 91 | 60 | 56 |
| strength (high-speed shaping) | (g/m²) | | | | | | |
| Rate of thermal shrinkage | % | 11 | 3 | 2 | 21 | 11 | 17 |
| (high-speed shaping) | | | | | | | |
| Performance balance | — | ⊚ | ⊚ | ⊚ | Δ | Δ | X |
| (high-speed shaping) | | | | | | | |

| | | Comparative | Comparative | Comparative | Comparative | Comparative |
|---|---|---|---|---|---|---|
| Item | Unit | Example 2 | Example 3 | Example 4 | Example 5 | Example 6 |
| Intrinsic viscosity IV | dL/g | 7.7 | 15.2 | 1.3 | 5.1 | 11.0 |
| Amorphous moiety thickness | nm | 7.1 | 9.4 | 10.6 | 5.1 | 3.2 |
| Crystallite size | nm | 13.7 | 15.7 | 16.2 | 14.3 | 14.8 |
| Ratio between monoclinic | — | 2.8 | 1.1 | 1.7 | 2.9 | 2.7 |
| crystal (010 plane) and | | | | | | |
| orthorhombic crystal | | | | | | |
| (110 plane) | | | | | | |
| Amount of Ti | ppm | 1.5 | 0.9 | 1.7 | 1.9 | 1.8 |
| Amount of Al | ppm | 2.9 | 2.0 | 3.4 | 3.9 | 3.6 |
| Average particle size D50 | μm | 222 | 241 | 213 | 204 | 208 |
| Presence or absence of | — | Homo- | Homo- | Homo- | Homo- | Homo- |
| α-olefin | | polymer | polymer | polymer | polymer | polymer |
| Basis weight-based | gf/ | 88 | Film not | Film not | 54 | 102 |
| puncture strength | (g/m²) | | formable | formable | | |
| Rate of thermal shrinkage | % | 18 | | | 11 | 25 |
| Performance balance | — | X | | | X | X |
| Basis weight-based puncture | gf/ | 90 | Film not | Film not | 57 | 104 |
| strength (high-speed shaping) | (g/m²) | | formable | formable | | |
| Rate of thermal shrinkage | % | 26 | | | 19 | 34 |
| (high-speed shaping) | | | | | | |
| Performance balance | — | X | | | X | X |
| (high-speed shaping) | | | | | | |

### INDUSTRIAL APPLICABILITY

The polyethylene powder of the present invention is excellent in balance between mechanical strength and a rate of thermal shrinkage and can provide, for example, a shaped article, such as a microporous membrane, excellent in balance between mechanical strength and a rate of thermal shrinkage even when shaped at a high speed, and thus has industrial applicability.

1: A polyethylene powder having:
an intrinsic viscosity IV of 1.5 dL/g or more and 15.0 dL/g or less measured in accordance with ISO1628-3 (2010),
an amorphous moiety thickness of 5.3 nm or larger and 12.0 nm or smaller, and
a crystallite size of 13.9 nm or larger and 18.0 nm or smaller obtained by a reflection method of X-ray diffraction.

2: The polyethylene powder according to claim 1, wherein a ratio between a monoclinic crystal (010 plane) and an orthorhombic crystal (110 plane) obtained by the reflection method of X-ray diffraction is 1.0 or more and 2.6 or less in terms of monoclinic crystal (010) plane diffraction peak intensity/orthorhombic crystal (110) plane diffraction peak intensity.

3: The polyethylene powder according to claim 1, wherein a Ti content is 10 ppm or less and an Al content is 20 ppm or less.

4: The polyethylene powder according to claim 1, wherein an average particle size D₅₀ determined by a sieving method is 80 μm or larger.

5: The polyethylene powder according to claim 1, wherein an α-olefin content is less than 0.03 mol %.

6: A shaped article comprising the polyethylene powder according to claim 1.

7: A separator for secondary battery comprising the shaped article according to claim 6.

8: A shaped article comprising the polyethylene powder according to claim 2.

9: A separator for secondary battery comprising the shaped article according to claim 8.

10: The polyethylene powder according to claim 2, wherein an average particle size D₅₀ determined by a sieving method is 80 μm or larger.

11: A shaped article comprising the polyethylene powder according to claim 10.

12: A separator for secondary battery comprising the shaped article according to claim 11.
